(19) United States
(12) Patent Application Publication
(10) Pub. No.: US 2014/0025203 A1
(43) Pub. Date: Jan. 23, 2014

(54) COLLISION DETECTION SYSTEM, COLLISION DETECTION DATA GENERATOR, AND ROBOT

(71) Applicant: Seiko Epson Corporation, Tokyo (JP)

(72) Inventor: Mitsuhiro Inazumi, Shiojiri (JP)

(21) Appl. No.: 13/921,437

(22) Filed: Jun. 19, 2013

(30) Foreign Application Priority Data
Jul. 20, 2012 (JP) 2012-161281

(51) Int. Cl. B25J 9/16

(52) U.S. Cl. CPC B25J 9/1666
USPC 700/255

(57) ABSTRACT

A collision detection system includes a memory unit that stores first collision detection data corresponding to a first object and second collision detection data corresponding to a second object as collision detection data of objects, and a processing unit that performs a collision determination between the first object and the second object in the world coordinate system based on the first collision detection data and the second collision detection data. The memory unit stores representative point data obtained by discretization of depth map data of the objects as seen from a predetermined viewpoint in model coordinate systems of the objects using cubic areas set in the model coordinate systems as the collision detection data.

### BACKGROUND

1. Technical Field

The present invention relates to a collision detection system, a collision detection data generator, a robot, or the like.

2. Related Art

Determinations as to whether or not there is a collision between objects or proximity to each other are required in many fields. For example, in a field of robots or the like, occurrence of collisions is an enormous problem. Accordingly, in related art, techniques of determining whether or not a collision or proximity beyond an acceptable level is to occur by calculation using a computer before the collision actually occurs have been studied and developed. As a related art of the collision determination technique, for example, a technology disclosed in Patent Document 1 (JP-A-11-250122) or the like has been known.

In the technique of Patent Document 1, an object is represented by polygon data, the respective polygons of the polygon data are covered by spheres having predetermined radii, those spheres are integrated into spheres having the larger radii, and the data of the spheres is configured as data having a binary tree structure representing the integration relations among the spheres. Further, collision determinations are sequentially performed on the data having the binary tree structure with respect to each layer, and thereby, a collision determination between objects is performed.

In the technique of performing collision detection using polygon data like Patent Document 1, CAD (Computer Aided Design) data of the objects to be detected is necessary. However, in practice, a lot of objects without CAD data and objects without available CAD data exist, and there is a problem that it is difficult to apply the technique to the objects.

### SUMMARY

An advantage of some aspects of the invention is to provide a collision detection system that can perform collision detection even in the case where polygon data of objects are not available or the like, a collision detection data generator, a robot system, a robot, a method of generating collision detection data, a program, or the like.

An aspect of the invention relates to a collision detection system including a memory unit that stores first collision detection data corresponding to a first object and second collision detection data corresponding to a second object as collision detection data of the objects, and a processing unit that performs a collision determination between the first object and the second object in the world coordinate system based on the first collision detection data and the second collision detection data, wherein the memory unit stores representative point data obtained by discretization of depth map data of the objects as seen from a predetermined viewpoint in model coordinate systems of the objects using cubic areas set in the model coordinate systems as the collision detection data.

According to the configuration, the representative point data obtained by discretization of the depth map data of the objects using the cubic areas set in the model coordinate systems is stored as the collision detection data in the memory unit, and the collision detection between the first object and the second object is performed based on the collision detection data. Thereby, even in the case where polygon data of the objects is unavailable or the like, collision detection may be performed.

In the aspect of the invention, the memory unit may store the representative point data of bounding boxes including the objects and divisional representative point data as the representative point data obtained by discretization of the depth map data using cubic areas formed by division of the bounding boxes as the collision detection data, and if determining a collision between the first bounding box including the first object and the second bounding box including the second object, the processing unit may perform the collision determination between the first object and the second object based on the divisional representative point data of the first object and the divisional representative point data of the second object.

According to the configuration, non-collision between the first object and the second object may be definitively determined at the stage of determination of non-collision between the bounding boxes, and thus, the collision determination in the smaller cubic areas may be omitted and the processing may be simplified.

In the aspect of the invention, the memory unit may store data having a tree structure as the collision detection data, and the data having the tree structure may have the representative point data corresponding to a plurality of cubic areas formed by division of a cubic area of a parent node as the representative point data of child nodes branching from the parent node.

According to the configuration, the collision detection may be sequentially performed with respect to each layer from the nodes of the upper layers to the nodes of the lower layers of the tree structure. By the recursive processing, the collision detection may be parallelized.

In the aspect of the invention, the plurality of cubic areas of the child nodes formed by division of the cubic area of the parent node may be 2×2×2 cubic areas obtained by division of the cubic area of the parent node as seen from the predetermined viewpoint into 2×2 areas and division of the respective areas of the 2×2 areas into two in a depth direction of the predetermined viewpoint, the data having the tree structure may be data having a quadtree structure in which the child nodes are set in correspondence with respective areas of the 2×2 areas as seen from the predetermined viewpoint, and the data of the child nodes in the quadtree structure may be the representative point data existing in at least one of the two cubic areas in the depth direction in the respective areas of the 2×2 areas.

The collision detection is performed based on the data having the quadtree structure, and thereby, the number of combinations of node pairs in the respective layers may be 4×4=16, and, for example, the collision detection system may be realized using a CPU (Central Processing Unit) for about several tens of threads or the like.

In the aspect of the invention, if the parent node determined to collide exists in the collision determination based on the data of the parent node, the processing unit may perform the collision determination based on the data of the child nodes branching from the parent node determined to collide, and if the parent node determined to collide does not exist in the collision determination based on the data of the parent node, the processing unit may definitively determine non-collision between the first object and the second object.

According to the configuration, recursive collision detection processing of sequentially performing collision detection with respect to each layer from the nodes of the upper layers to the nodes of the lower layers of the tree structure may be realized. Further, if there is a layer in which non-collision has been determined with respect to all combinations of node pairs, non-collision between the first object and the second object may be definitively determined at the stage of processing of the layer, and the processing may be simplified.

In the aspect of the invention, the depth map data may be depth map data generated by three-dimensional information measurement equipment that measures three-dimensional information of the objects.

Another aspect of the invention relates to a collision detection data generator including a depth map data acquisition unit that acquires depth map data of an object as seen from a predetermined viewpoint in a model coordinate system of the object, and a collision detection data generation unit that generates representative point data in the model coordinate system of the object as collision detection data, wherein the collision detection data generation unit generates the representative point data by discretization of the depth map data using cubic areas set in the model coordinate system of the object.

According to the aspect of the invention, the depth map data of the object is discretized using the cubic areas set in the model coordinate system and the representative point data is generated as the collision detection data by the discretization. The collision detection data is generated in this manner, and thereby, even when polygon data of the object is unavailable, collision detection may be performed.

In the aspect of the invention, the collision detection data generation unit may generate data having a tree structure as the collision detection data by connecting nodes corresponding to a plurality of cubic areas formed by division of a cubic area of a parent node as child nodes to the parent node.

In this manner, the data having the tree structure may be formed from the representative point data obtained by discretization of the depth map data. Further, the data having the tree structure is generated, and thereby, recursive parallel processing may be performed in the collision detection.

In the aspect of the invention, the plurality of cubic areas of the child nodes formed by division of the cubic area of the parent node may be 2×2×2 cubic areas obtained by division of the cubic area of the parent node as seen from the predetermined viewpoint into 2×2 areas and division of the respective areas of the 2×2 areas into two areas in a depth direction of the predetermined viewpoint, the collision detection data generation unit may generate data having a quadtree structure in which the child nodes are set in correspondence with the respective areas of the 2×2 areas as seen from the predetermined viewpoint as the data having the tree structure, and the data of the child nodes in the data having the quadtree structure may be the representative point data existing in at least one of the two cubic areas in the depth direction in the respective areas of the 2×2 areas.

According to the configuration, the child nodes are set in correspondence with the respective areas of the 2×2 areas as seen from the predetermined viewpoint, and thereby, the data having the quadtree structure may be formed from the representative point data obtained by discretization of the depth map data using the cubic areas.

In the aspect of the invention, if judging that there is a cubic area without representative point data between a representative point as a target of processing and representative points existing outside of the surrounding 26 adjacent cubic areas of the representative point as the target of processing, the collision detection data generation unit may complement the cubic area without the representative point data with the representative point data.

The collision detection data is generated in this manner, and thereby, erroneous detection such that non-collision is determined despite of a collision probability in the cubic areas without the representative point data may be suppressed.

In the aspect of the invention, when a depth value is larger as farther in the depth direction of the predetermined viewpoint, if determining that a difference value obtained by subtraction of a representative depth value of the representative points existing around the representative point as the target of processing from a representative depth value of the representative point as the target of processing is negative, the collision detection data generation unit complements the cubic area at the depth direction side with respect to the representative point as the target of processing with the representative point data.

According to the configuration, if the difference value is negative, the representative point exists at the deeper direction side than the representative point as the target of processing, and thus, the cubic area at the depth direction side with respect to the representative point data as the target of processing may be complemented with the representative point data.

In the aspect of the invention, the depth map data may be depth map data generated by three-dimensional information measurement equipment that measures three-dimensional information of the objects.

Still another aspect of the invention relates to a robot system including a robot having a movable unit, a memory unit that stores first collision detection data corresponding to a first object and second collision detection data corresponding to a second object as collision detection data of the objects, a processing unit that performs a collision determination between the first object and the second object in the world coordinate system based on the first collision detection data and the second collision detection data, and a control unit that controls a movement of the movable unit based on a result of the collision determination performed by the processing unit, wherein the memory unit stores representative point data obtained by discretization of depth map data of the objects as seen from a predetermined viewpoint in model coordinate systems of the objects using cubic areas set in the model coordinate systems as the collision detection data.

Yet another aspect of the invention relates to a robot including a movable unit, a memory unit that stores first collision detection data corresponding to a first object and second collision detection data corresponding to a second object as collision detection data of the objects, a processing unit that performs a collision determination between the first object and the second object in the world coordinate system based on the first collision detection data and the second collision detection data, and a control unit that controls a movement of the movable unit based on a result of the collision determination performed by the processing unit, wherein the memory unit stores representative point data obtained by discretization of depth map data of the objects as seen from a predetermined viewpoint in model coordinate systems of the objects using cubic areas set in the model coordinate systems as the collision detection data.

Still yet another aspect of the invention relates to a method of generating collision detection data including acquiring depth map data of an object as seen from a predetermined viewpoint in a model coordinate system of the object, discretizing the depth map data using cubic areas set in the model coordinate system of the object, and generating representative point data obtained by the discretization as the collision detection data.

Further another aspect of the invention relates to a program allowing a computer to function as a depth map data acquisition unit that acquires depth map data of an object as seen from a predetermined viewpoint in a model coordinate system of the object, and a collision detection data generation unit that generates representative point data in the model coordinate system of the object as collision detection data, wherein the collision detection data generation unit generates the representative point data by discretization of the depth map data using cubic areas set in the model coordinate system of the object.

### BRIEF DESCRIPTION OF THE DRAWINGS

The invention will be described with reference to the accompanying drawings, wherein like numbers reference like elements.

FIG. 1A shows a configuration example of a collision detection data generator of an embodiment. FIG. 1B shows a configuration example of a collision detection system of the embodiment.

FIG. 2A shows an example of a robot system including the collision detection system of the embodiment. FIG. 2B shows an example of a robot including the collision detection system of the embodiment.

FIG. 3 is an explanatory diagram of a technique of generating collision detection data.

FIG. 4 is an explanatory diagram of the technique of generating collision detection data.

FIG. 5 is an explanatory diagram of the technique of generating collision detection data.

FIG. 6 is an explanatory diagram of the technique of generating collision detection data.

FIG. 7 is an explanatory diagram of the technique of generating collision detection data.

FIG. 8 is an explanatory diagram of the technique of generating collision detection data.

FIGS. 9A to 9C show an example of data having a quadtree structure generated by the collision detection data generator of the embodiment.

FIGS. 10A and 10B show an example of data having a quadtree structure generated by the collision detection data generator of the embodiment.

FIGS. 11A to 11C show an example of data having a quadtree structure generated by the collision detection data generator of the embodiment.

FIG. 12 is an explanatory diagram of a technique of collision detection.

FIGS. 13A to 13C are explanatory diagrams of a technique of collision detection.

FIG. 14 is an explanatory diagram of a technique of collision detection.

FIG. 15 is an explanatory diagram of a technique of collision detection.

FIG. 16 is an explanatory diagram of a technique of collision detection.

FIG. 17 shows a detailed configuration example of the collision detection data generator of the embodiment.

FIG. 18 is a flowchart of collision detection data generation processing.

FIG. 19 is a detailed flowchart of data generation processing for one layer.

FIG. 20 is a detailed flowchart of quadtree structure generation processing.

FIG. 21 shows a detailed configuration example of the collision detection system of the embodiment.

FIG. 22 is a flowchart of collision detection processing.

FIG. 23 is a detailed flowchart of recursive node-pair collision detection processing.

### DESCRIPTION OF EXEMPLARY EMBODIMENTS

As below, embodiments of the invention will be explained. Note that the embodiments to be explained do not unduly limit the invention described in the appended claims, and all of the configurations to be explained in the embodiments are not necessarily essential as solving means of the invention.

### 1. Configuration

In movements of a robot (manipulator), collisions with peripheral structures and peripheral devices, self-collisions, and collisions with other robots are enormously problematic. In a collision detection technique of the embodiment, the collisions are detected in advance by simulations.

As modes in which the collision detection technique of the embodiment is used, roughly, off-line use (prior confirmation) and run-time use (prediction, anticipation) are considered. In the off-line use, if the surrounding environment or the like is known and statistic and the movement of the robot is known, the collision is verified at creation of a system. On the other hand, in the run-time use, if the surrounding environment or the like dynamically changes (for example, if robots exist or a worker exists around), a collision is detected by a simulation prior to the actual movement of the robot.

In related art, as the collision detection technique in the robot, an algorithm on the assumption that polygon data of an object is available has been often used. The polygon data is CAD data representing the shape of the object by a combination of many polygons at design of the structure of the object or the like. However, there has been a problem that collision detection is performed on a wide variety of objects and, in practice, it is difficult to obtain CAD data with respect to all of them.

Further, the collision detection technique using polygon data in related art includes a technique of generating spherical data having a binary tree structure with respect to each polygon and performing collision detection using the data like the above described Patent Document 1. However, according to the technique, it is difficult to perform efficient collision detection because large volumes of unwanted collision detection data and unwanted collision detection processing are generated.

Specifically, the polygon data describing a real object does not necessarily include only the polygon data of the surface of the important object in the collision detection. The polygon data includes large volumes of polygon data representing the object interior, polygon data representing parts unseen from the outside of the object, or the like as the unimportant polygon data in the collision detection. If spherical data is generated in units of polygons from the polygon data, the data having the binary tree structure includes a large volume of spherical data irrelevant to the collision detection. Patent Document 1 does not refer to how to handle the unimportant polygon data in the collision detection, and the collision detection processing is also performed on the spherical data irrelevant to the collision detection and leads to inefficient processing.

Furthermore, the polygon data describing the real object includes polygons in a wide variety of sizes, and it is not efficient to handle them with the same algorithm. For example, many of the parts of the robot and the tools handled by the robot are thin rod-like objects, and the objects are represented by micro polygons. Further, many micro polygons are used for the complex shapes of the objects or the like. It is considered that the necessary size of the sphere covering the polygon is the size of about the acceptable range of proximity, and, if the structure represented by the smaller polygons is represented by data having a tree structure, the data becomes very redundant. Accordingly, though the micro structures are less important in collision detection, a large volume of unwanted collision detection processing is generated due to the micro structures.

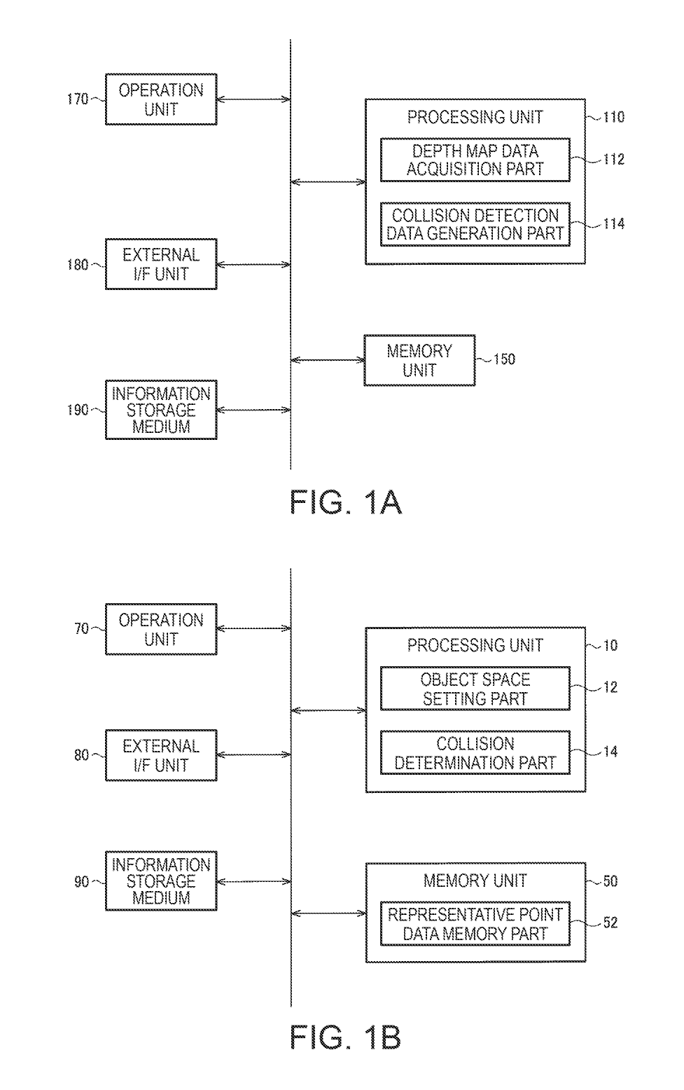

FIG. 1A shows a configuration example of a collision detection data generator of the embodiment that may solve the above described problems. Note that the configuration of the collision detection data generator of the embodiment is not limited to the configuration in FIG. 1A, but various modifications such that part of the component elements (for example, an operation unit, an external I/F unit, or the like) is omitted or another component element is added may be made.

The collision detection data generator includes a processing unit 110 and a memory unit 150. Further, the collision detection data generator may include an operation unit 170, an external I/F (interface) unit 180, an information storage medium 190. The collision detection data generator includes information processing equipment, for example, and the collision detection data generator is realized by hardware and programs of the information processing equipment.

The processing unit 110 performs various data generation processing, control processing, etc., and may be realized by various processors of CPU or the like, hardware such as a dedicated circuit (ASIC), and programs executed on the processors. The processing unit 110 includes a depth map data acquisition part 112, and a collision detection data generation part 114.

The depth map data acquisition part 112 performs processing of acquiring depth map data for generating collision detection data. Here, the depth map is a map represented by depth values of an object as seen from a predetermined viewpoint (for example, an infinite viewpoint) in which depth values in units of pixels are arranged in a matrix. To the depth map data acquisition part 112, for example, CAD data previously saved in the information storage medium 190 is input or measurement information from three-dimensional information measurement equipment (not shown, for example, a 3D scanner) is input via the external I/F unit 180. Then, the depth map data acquisition part 112 generates depth map data from the input CAD data and measurement information.

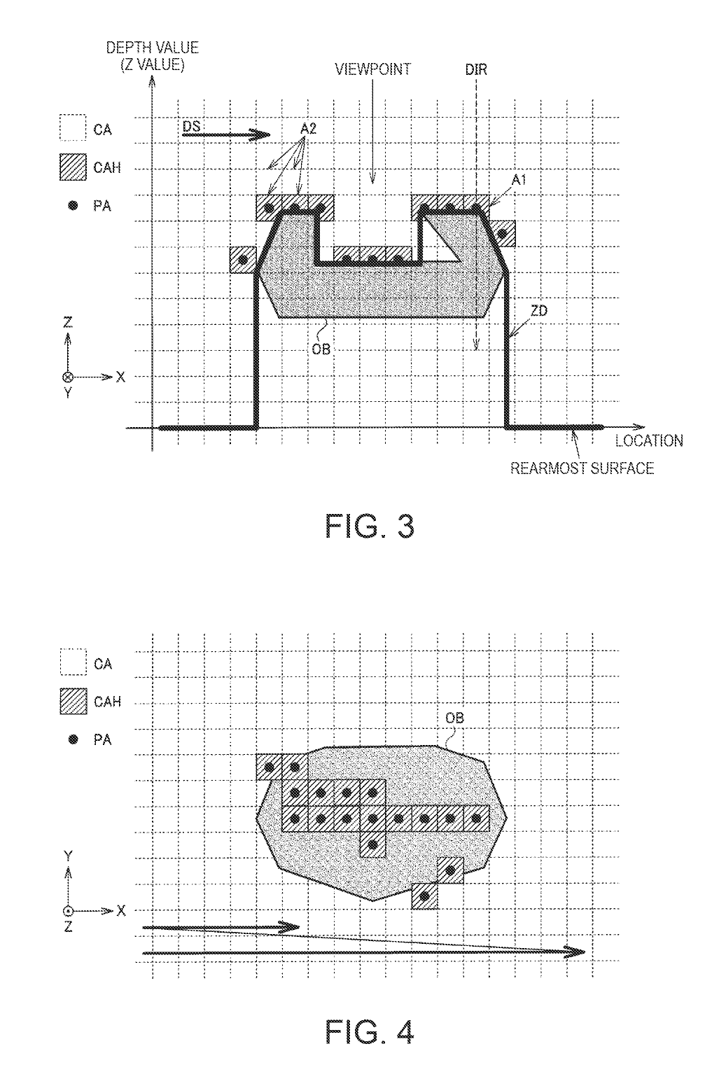

The collision detection data generation part 114 performs processing of generating data for use in collision detection processing from the depth map data. Specifically, as will be described with FIG. 3 etc., locations and depth values in the depth map data are discretized using cubic areas, and the discretized representative value data covering the surface of the object is generated as the collision detection data. The collision detection data generation part 114 generates representative point data while sequentially dividing (or integrating) the size of the cubic area, and forms data having a tree structure representing subordinate relations of the division (or integration). The generated collision detection data is stored in the information storage medium 190.

The memory unit 150 serves as a work area for the processing unit 110 or the like, and may be realized by a memory such as RAN (SRAM, DRAM, or the like). The operation unit 170 is provided for a user to input various operation information. The external I/F unit 180 performs wired or wireless external communication processing of information or the like. The information storage medium 190 (computer-readable medium) stores programs and data and its function may be realized by an optical disk, an HDD, a memory, or the like. The processing unit 110 performs various processing of the embodiment based on the programs (data) stored in the information storage medium 190. That is, in the information storage medium 190, programs for allowing a computer (equipment including an operation unit, a processing unit, a memory unit, and an output unit) to function as the respective units of the embodiment (programs allowing the computer to execute processing of the respective units) are stored.

FIG. 1B shows a configuration example of a collision detection system of the embodiment that may solve the above described problems. Note that the configuration of the collision detection system of the embodiment is not limited to the configuration in FIG. 1B, but various modifications such that part of the component elements (for example, an operation unit, an external I/F unit, or the like) is omitted or another component element is added may be made.

The collision detection system includes a processing unit 10 and a memory unit 50. Further, the collision detection system may include an operation unit 70, an external I/F (interface) unit 80, an information storage medium 90.

The memory unit 50 serves as a work area for the processing unit 10 or the like, and may be realized by a memory such as RAN (SRAM, DRAM, or the like). The memory unit 50 includes a representative point data memory part 52.

The representative point data memory part 52 stores the collision detection data generated by the collision detection data generator. For example, the collision detection data generator is formed separately from the collision detection system, and the collision detection data is stored in the information storage medium 90 via the external I/F unit 80. Further, when the collision detection processing is executed, the processing unit 10 develops the collision detection data of the information storage medium 90 in the RAM of the memory unit 50, and performs collision detection processing with reference to the data on the RAM. Note that the collision detection data generator may be integrally formed with the collision detection system. In this case, the processing unit 10 contains the depth map data acquisition part 112 and the collision detection data generation part 114, and the collision detection data generated by the processing unit 10 is stored in the information storage medium 90.

The processing unit 10 performs various determination processing, control processing, etc., and may be realized by various processors of CPU or the like, hardware such as a dedicated circuit (ASIC), and programs executed on the processors. The processing unit 10 includes an object space setting part 12 and a collision determination part 14.

The object space setting part 12 performs processing of arranging and setting a plurality of objects in an object space or the like. Specifically, locations and rotation angles of the objects in the world coordinate system are determined and the objects are arranged in the locations at the rotation angles. Here, the world coordinate system is a coordinate system set in the space in which the collision detection processing is performed, and set with respect to the objects as targets of collision detection in common. Further, the object refers to one formed by modeling of a collision detection target object such as a robot or a collision detected target object such as a peripheral structure or peripheral device. In the embodiment, model coordinate systems are respectively set for the respective objects, and the objects are represented by representative point data in the model coordinate systems. The object space setting part 12 arranges the objects in the world coordinate system by conversion of the coordinates of the representative point data in the model coordinate systems into the coordinates in the world coordinate system.

The collision determination part 14 performs collision determination processing between an object as a collision detection target (first object) and an object as a collision detected target (second object). Specifically, as will be described later with FIG. 8 and subsequent drawings, a collision determination is performed using representative point data in the upper layers having the larger cubic areas, if nodes determined to collide (having a collision possibility) exist, a collision determination is performed using representative point data of child nodes of the nodes. If nodes determined to collide exist in the lowermost layer, collision is definitively determined, and if non-collision (having no collision possibility) is determined in the upper layer than the lowermost layer, collision determinations of the lower layers than the layer determined as non-collision are not performed, and non-collision is definitively determined.

The operation unit 70 is provided for a user to input various operation information. The external I/F unit 80 performs wired or wireless external communication processing of information or the like. The information storage medium 90 (computer-readable medium) stores programs and data and its function may be realized by an optical disk, an HDD, a memory, or the like. The processing unit 10 performs various processing of the embodiment based on the programs (data) stored in the information storage medium 90. That is, in the information storage medium 90, programs for allowing a computer (equipment including an operation unit, a processing unit, a memory unit, and an output unit) to function as the respective units of the embodiment (programs allowing the computer to execute processing of the respective units) are stored.

As described above, the collision detection data is generated by discretization of the depth map data using the cubic areas, and thereby, collision detection may be performed even for an object without available CAD data. Further, the representative point data includes only data representing important object surfaces for collision detection, and efficient collision detection processing may be performed. Furthermore, the representative point data is non-redundant data independent of the size of the polygons, and unwanted collision detection processing may be suppressed.

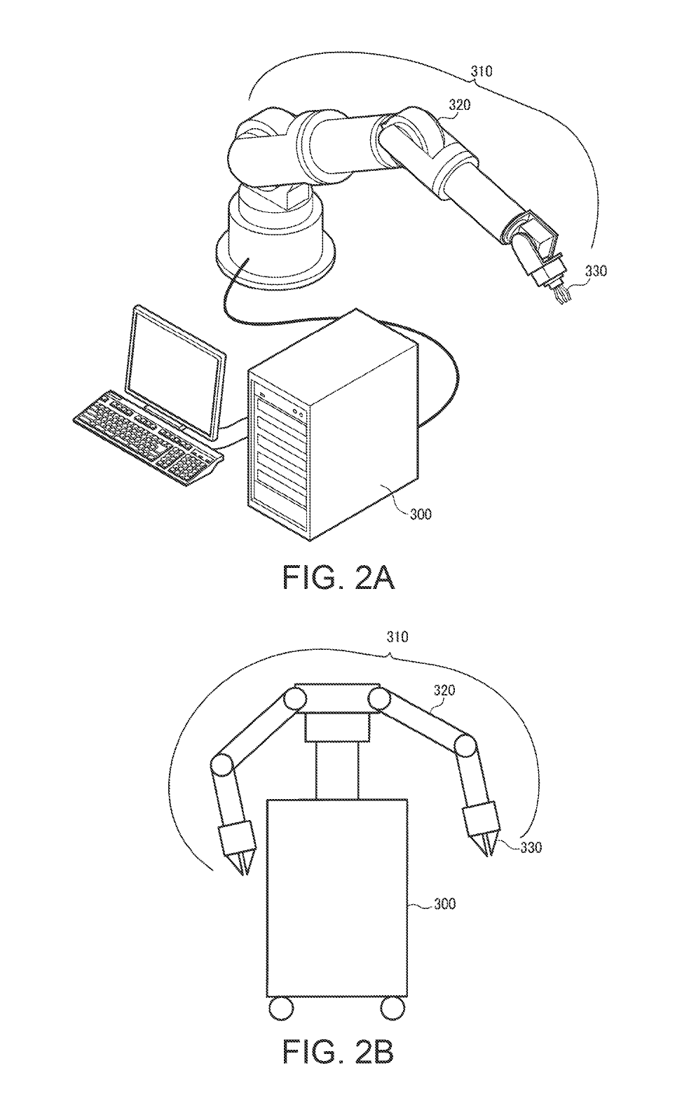

FIG. 2A shows an example of a robot system including the collision detection system of the embodiment. The robot system includes a controller 300 (information processing equipment) and a robot 310. The controller 300 performs control processing of the robot 310. Specifically, the controller performs control to move the robot 310 based on the movement sequence information (scenario information). The robot 310 has movable parts such as an arm 320 and a hand (grasping part) 330. Further, the movable parts move according to a movement command from the controller 300. For example, the movable parts perform movements of grasping and translating work placed on a palette (not shown). Alternatively, information on the position of the robot and the location of the work is detected based on taken image information acquired by imaging equipment (not shown), and the detected information is sent to the controller 300.

Here, the movable parts change (translate) the relative distance and position between objects by movements of the movable parts. For example, the robot 310 of the embodiment has the robot arm 320 and the hand 330 and, when work is performed by moving the robot arm 320 and the hand 330, the respective parts forming the robot arm 320 and the hand 330 and joints that joint the parts correspond to the movable parts. In this example, the hand 330 holds (or grasps, suctions) the object and the robot arm 320 and the hand 330 move, and thereby, the object held by the hand 330 and the object around the robot 310 (for example, structures, installed objects, parts, or the like) relatively translate. Or, the robot arm 320 and the hand 330 move, and thereby, the parts forming the robot arm 320 and the hand 330 and the objects around the robot 310 relatively translate or the parts and parts jointed by the joints of the robot arm 320 and the hand 330 relatively translate. In the embodiment, collision between objects translated by the movable parts is detected.

The collision detection system of the embodiment is provided in the controller 300 in FIG. 2A, for example, and the collision detection system is realized by hardware and programs of the controller 300, for example. Further, in run-time use, when the surrounding environment dynamically changes, prior to the actual movement of the robot 310, the collision detection system of the embodiment performs determination processing of collisions by simulations. Then, the controller 300 performs control of the robot 310 based on the result of the determination processing so that the robot 310 may not collide with a peripheral structure, peripheral device, or the like. On the other hand, in off-line use, the collision detection system of the embodiment verifies collisions by simulations when the movement sequence information or the like is created. Then, the controller 300 controls the robot 310 based on the movement sequence information (scenario information) created for prevention of collisions.

Note that, although FIG. 2A shows the example of the robot system in which the robot 310 and the controller 300 separately exist, in the embodiment, the robot 310 may contain the controller 300.

FIG. 2B shows an example of a robot including the collision detection system of the embodiment. The robot includes a robot main body 310 (having the arm 320 and the hand 330) and a base unit part supporting the robot main body 310, and the controller 300 is held in the base unit part. In the robot of FIG. 2B, wheels or the like are provided in the base unit part so that the whole robot may be translated. Note that, although FIG. 2A shows the single-arm example, the robot may be a multi-arm robot such as a dual-arm robot as shown in FIG. 2B. The translation of the robot may be manually performed, or may be performed by providing a motor for driving the wheels and controlling the motor by the controller 300.

### 2. Technique of Generating Collision Detection Data

A technique of generating collision detection data in the embodiment will be explained. Note that, in FIGS. 3 to 7, a model coordinate system is set for the object OB and the model coordinate system is represented by orthogonal XYZ coordinates of the right-handed system.

As shown in FIG. 3, the depth map data acquisition part 112 acquires depth map data ZD of the object OB as seen from predetermined viewpoints (lines of sight). The predetermined viewpoints are six viewpoints (lines of sight) in which the object OB is seen from the +Z-direction side, the −Z-direction side, +X-direction side, the −X-direction side, +Y-direction side, and the −Y-direction side. The depth map data acquisition part 112 acquires depth map data on the respective six viewpoints. FIG. 3 shows a sectional view of the depth map data ZD on the XZ-plane as seen from the viewpoint at the +Z-direction side as an example. In this example, the depth value of the depth map data changes along the Z-axis of the model coordinate system, and the location (pixel location) on the depth map data changes along the X-axis, Y-axis of the model coordinate system.

The collision detection data generation part 114 discretizes the X-coordinates, the Y-coordinates, and the Z-coordinates at predetermined intervals, and discretizes the space in which the model coordinate system is set (hereinafter, appropriately referred to as “model space”) in cubic areas CA. The cubic areas CA are areas fixed with respect to the model space and the object OB, and set in the same location as seen from any of the six viewpoints.

The collision detection data generation part 114 scans the discretized model space along the direction DS (for example, +X-direction), and sets representative points PA in cubic areas CAH corresponding to the surface (outline) of the object OB. Specifically, when attention is focused on a column DIR of the cubic areas having the same XY-coordinates, as shown by A1, the representative point is set in the cubic area first intersecting with the object OB when the column DIR is seen from the viewpoints. Then, the processing is sequentially performed along the direction DS, and the representative points PA are set on the surface of the object OB as seen from the view points. The representative point is set to the center of gravity of the cubic area, for example, and expressed by the XYZ-coordinates of the center of gravity. The representative points PA is not set in the area corresponding to the rearmost surface in the depth map data. The rearmost surface is a surface at the depth farthest from the viewpoints in the depth range that may be represented by the depth value.

Here, the discretization in the model space corresponds to discretization of the depth values and their locations in the depth map data, and the representative depth values and the representative locations in the depth map data are determined in correspondence with the representative points in the model space. In the example of FIG. 3, the Z-coordinate of the representative point corresponds to the representative depth value and the XY-coordinates of the representative point correspond to the representative location.

As shown in FIG. 4, the collision detection data generation part 114 performs scan in the +X-direction while sequentially translating in the +Y-direction, for example, and performs setting processing of the representative points PA with respect to all of the discretized XY-coordinates. FIG. 4 shows only part of the set representative points PA, however, the representative points PA are set to cover the object OB when scan is finished.

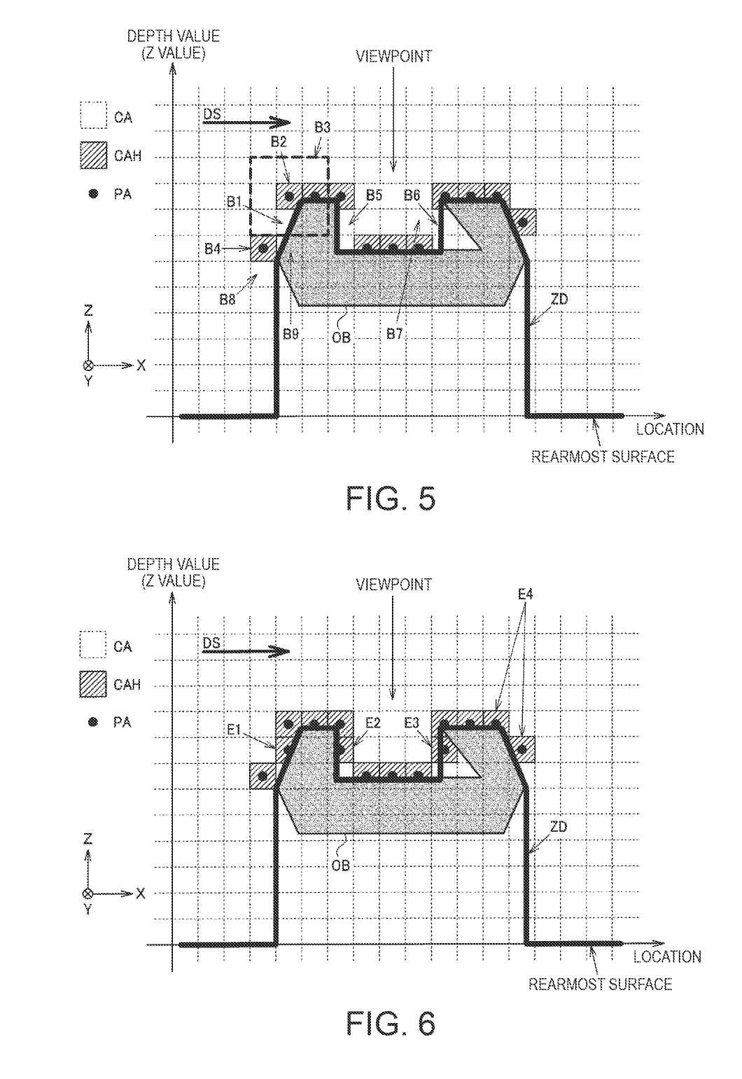

As shown by B1 in FIG. 5, even when the above described setting processing of the representative points is performed, the representative points may not cover up the surface of the object OB. This is because the representative points are set only in one cubic area of the cubic areas having the same XY-coordinates. When a collision determination is made using data without the representative points, if another object comes closer to the cubic area shown by B1 from the −X-direction, the probability of collision may not be correctly detected.

Accordingly, as shown by E1 in FIG. 6, the collision detection data generation part 114 performs processing of complementing (supplementing) the representative points so that the surface of the object OB may be continuously covered. Specifically, when attention is focused on representative points and the cubic areas shown by B2 in FIG. 5 (processing is performed thereon), the part determines whether or not the representative points are lost in the surrounding 26 adjacent cubic areas shown by B3. That is, as shown by B4, when the surrounding 26 adjacent cubic areas are seen from the viewpoint, if the representative point exists at the farther side (at the deeper side, in the −Z-direction side in FIG. 5) than the surrounding 26 adjacent cubic areas, the cubic area shown by B1 adjacent at the farther side of the cubic area shown in Fig. B2 is complemented with the representative point. Here, the surrounding 26 adjacent cubic areas are nearest 26 (=3×3×3−1) cubic areas surrounding the cubic area of interest. FIG. 5 shows the two-dimensional sectional view and there are eight adjacent areas, however, in three dimensions, the cubic areas existing at the ±Y-direction sides with respect to the cubic area of interest are added and there are 26 adjacent areas in total.

The collision detection data generation part 114 performs the complementary processing while performing scanning in the direction DS (for example, +X-direction), and complements the cubic areas without representative points as shown by B5, B6 in FIG. 5 with the representative points as shown by E2, E3 in FIG. 6. Then, the part performs scanning in the direction DS while sequentially translating in the +Y-direction, and performs complementary processing with respect to all of the discretized XY-coordinates.

In this manner, the representative point data by which the surface of the object OB is continuously covered is finally generated, and thereby, the collision probability with the object OB may be correctly detected. Note that the farther side (B1) of the representative point (B2 in FIG. 5) of interest is complemented with the representative point so that the convex part of the object OB may not be thicker. Suppose that the side nearer the viewpoint than the representative point of interest is complemented with the representative point, for example, not the cubic area shown by B6, but the cubic area shown by B7 is complemented with the representative point. Then, the convex part represented by the representative points uselessly becomes thicker than the actual convex part, and a collision probability may be determined despite of non-collision with the convex part. In the embodiment, the farther side of the representative point of interest is complemented with the representative point, the convex part does not become thicker and the correct collision determination may be made.

Here, in FIG. 5, the case where the distance between the cubic area of B2 and the cubic area of B4 corresponds to one cubic area has been explained as an example, however, when the distance corresponds to two cubic areas or more, the two or more cubic areas are complemented with the representative points. For example, if the representative point shown in B4 exists in the location shown by B8, the cubic area shown by B9 is complemented with the representative point in addition to the cubic area shown by B1.

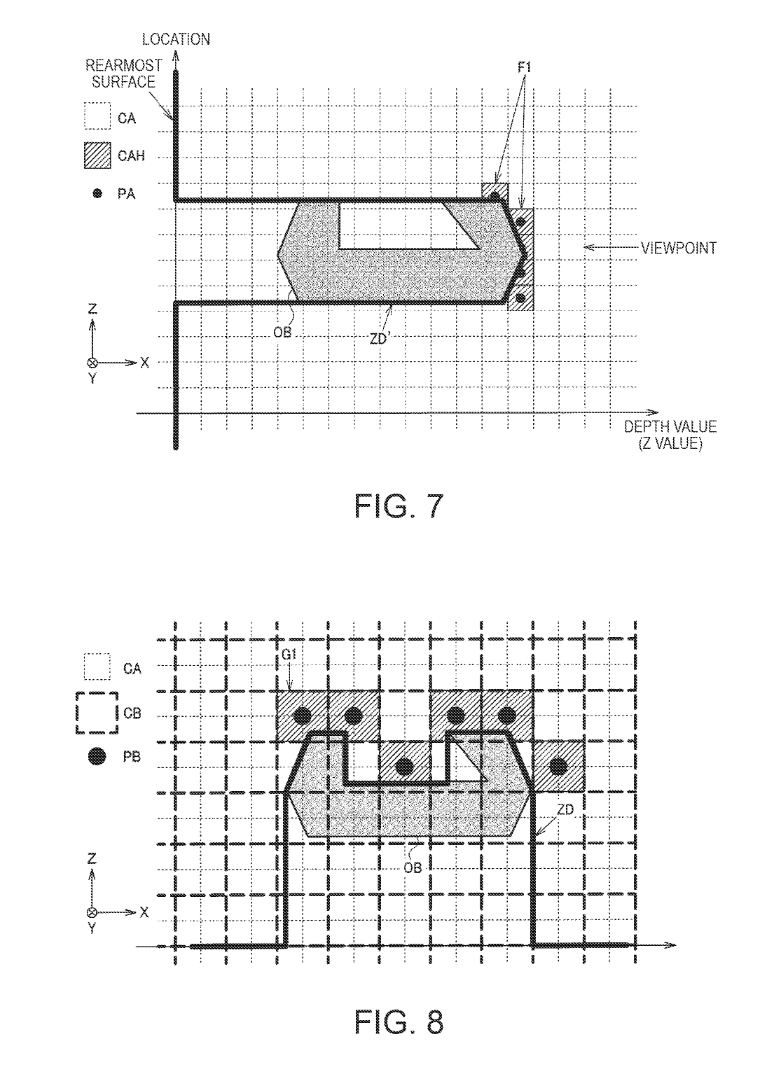

FIG. 7 is a sectional view on the XZ-plane of depth map data ZD′ as seen from a viewpoint at the +X-direction side. In FIG. 7, the depth value of the depth map data changes along the X-axis of the model coordinate system, and the location (pixel location) in the depth map data changes along the Y-axis, Z-axis of the model coordinate system.

As shown in FIG. 7, the collision detection data generation part 114 generates representative point data from the depth map data ZD′ with respect to other viewpoints than the viewpoint as seen from the +Z-direction side according to the above described technique. In this regard, as in the representative points shown in F1 in FIG. 7, the representative points may overlap with the representative points in the other viewpoints shown by E4 in FIG. 6. The collision detection data generation part 114 deletes the overlapping representative points as shown in F1, and generates final representative point data in the viewpoint as seen from the +X-direction side. Then, with the representative point data generated in the six viewpoints, collision detection data in which the surface of the object OB is covered by the representative points as seen from any viewpoint is generated.

As shown in FIG. 8, the collision detection data generation part 114 discretizes the model space while changing the size of the cubic areas, and generates data of representative points PB corresponding to the cubic areas CB. The size of the cubic area CB is twice in the length of the side of the cubic area CA, and each area formed by division of the cubic area CB into 2×2×2 areas corresponds to the cubic area CA. The collision detection data generation part 114 performs data generation processing while sequentially enlarging the size of the cubic areas, generates representative point data corresponding to the respective sizes, and generates data having a quadtree structure by integration of them. The uppermost cubic area in the quadtree is a cubic area including the object OB (bounding box). Further, in the quadtree, the size of the cubic areas in the lowermost layer may be set to about an allowable error (for example, several centimeters) in the collision detection of the robot or the like.

In the processing with respect to each layer as has been explained, processing for one layer corresponds to three-dimensional vector quantization of the depth map. Further, the collision detection data corresponds to data with different quantization steps of the three-dimensional vector quantization integrated into the quadtree structure. The quantization step in the three-dimensional vector quantization corresponds to the size of the cubic area, and the data having the same quantization step is integrated as data of the same layer into the quadtree structure.

Note that the size ratio between the cubic areas CA, CB is not limited to twice, but may be three times, four times, or the like, for example. Further, in the above description, the case where the data is generated while the size of the cubic area is sequentially increased has been explained as an example, and the embodiment is not limited thereto, but data may be generated while the size of the cubic area is sequentially reduced (for example, to a half).

### 3. Data Configuration Example

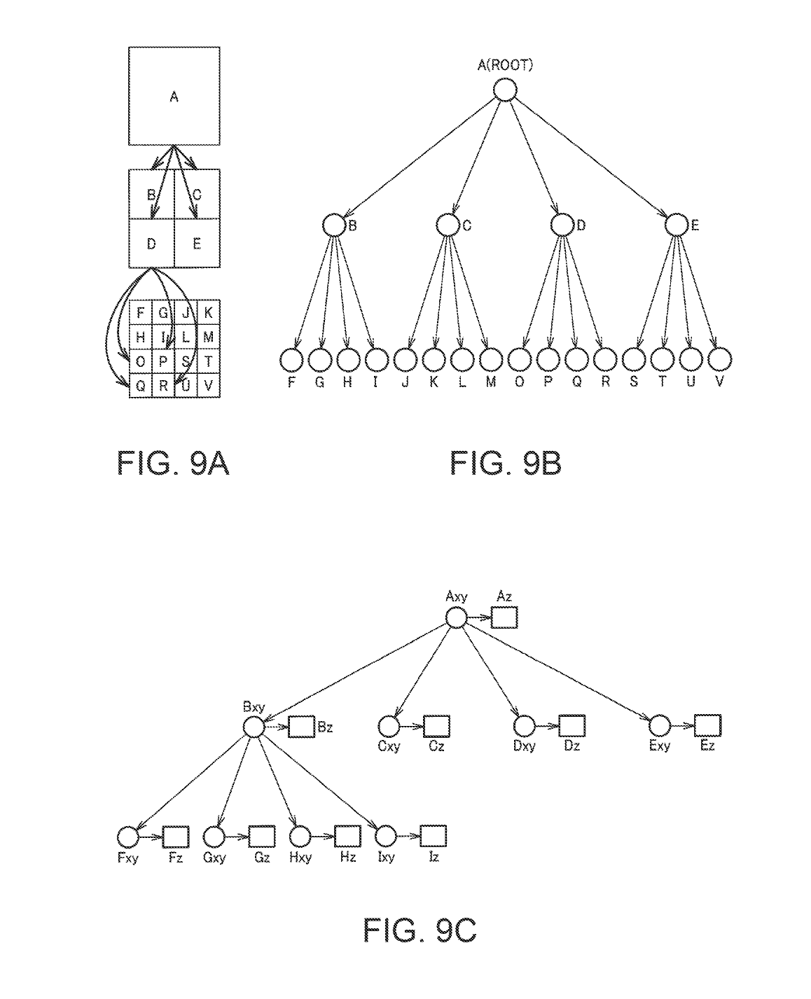

FIGS. 9A to 11C show examples of data having a quadtree structure generated by the collision detection data generator of the embodiment. Note that, as below, the case where three-layered data is generated in the viewpoint as seen from the +Z-direction side as a predetermined viewpoint will be explained.

FIG. 9A shows division relationships of cubic areas as seen from the +Z-direction side. The areas A to V represent areas formed by vertical projection of the cubic areas with respect to the XY-plane. The area A corresponds to a cubic area including the object OB. Further, the cubic area including the object OB is divided into 2×2×2 areas and the respective cubic areas are further divided into 2×2×2 areas, and accordingly, the area A is divided into 2×2 areas of B to D, the areas B to D are respectively divided into 2×2 areas of F to I, J to M, O to R, and S to V.

As shown in FIG. 9B, the representative point data is formed in a quadtree structure according to the division relationships of the areas A to V. That is, on node A at the uppermost (root) of the quadtree structure, the representative point data of the cubic area including the object OB corresponding to the area A in FIG. 9A is set. Further, on child nodes B to E with the node A as a parent node, representative point data existing in the areas B to E in FIG. 9A is set. Here, two cubic areas are arranged respectively in the Z direction in the areas B to E, and the representative point is basically set in one of the two cubic areas arranged in the Z direction. For example, when the cubic area in which the representative point is set as shown by G1 in FIG. 8 is divided, the cubic areas shown by A2 in FIG. 3 are obtained. When the cubic areas shown by A2 in FIG. 3 are seen from the viewpoint, the representative point is set in one of the two cubic areas arranged in the Z direction. On the nodes B to E, the representative point data existing in one of the two cubic areas is basically set. Similarly, the representative point data existing in the areas F to I, J to M, O to R, and S to V in FIG. 9A are set on the child nodes F to I, J to M, O to R, and S to V with the nodes B to E as parent nodes.

FIG. 9C shows a data configuration example of the respective nodes. Note that, for simplicity, the child nodes of the nodes C to E are omitted. As shown in FIG. 9C, the nodes A to V include nodes Axy to Vxy and sub-nodes Az to Vz as subordinates to the nodes Axy to Vxy. The XY-coordinates of the representative points are stored in the nodes Axy to Vxy, and the depth values (Z values) of the representative points are stored in the sub-nodes Az to Vz. In the case of the representative point data in the viewpoints as seen from the ±X, ±Y-direction sides, the depth values change in the X, Y-directions, and appropriate coordinate conversion is performed so that the depth value may change in the Z direction to form a quadtree. Alternatively, in the representative point data in the viewpoints as seen from the ±X, ±Y-direction sides, the YZ, ZX-coordinates of the representative points may be stored in the nodes Axy to Vxy, and the depth values in the X, Y-directions may be stored in the sub-nodes Az to Vz.

Here, in the above described tree structure in which a plurality of child nodes are connected to a parent node, the generation in the parent-child relationship of the nodes is referred to as a layer of data. That is, in the parent-child relationship of the nodes, the nodes in the same generation are the nodes in the same layer. For example, in the example of FIG. 9B, the root node A forms one layer and the child nodes B to E of the root node A form one layer. Further, the child nodes F to V with the child nodes B to E as the parent nodes (the grand-child nodes as seen from the root node A) further form one layer.

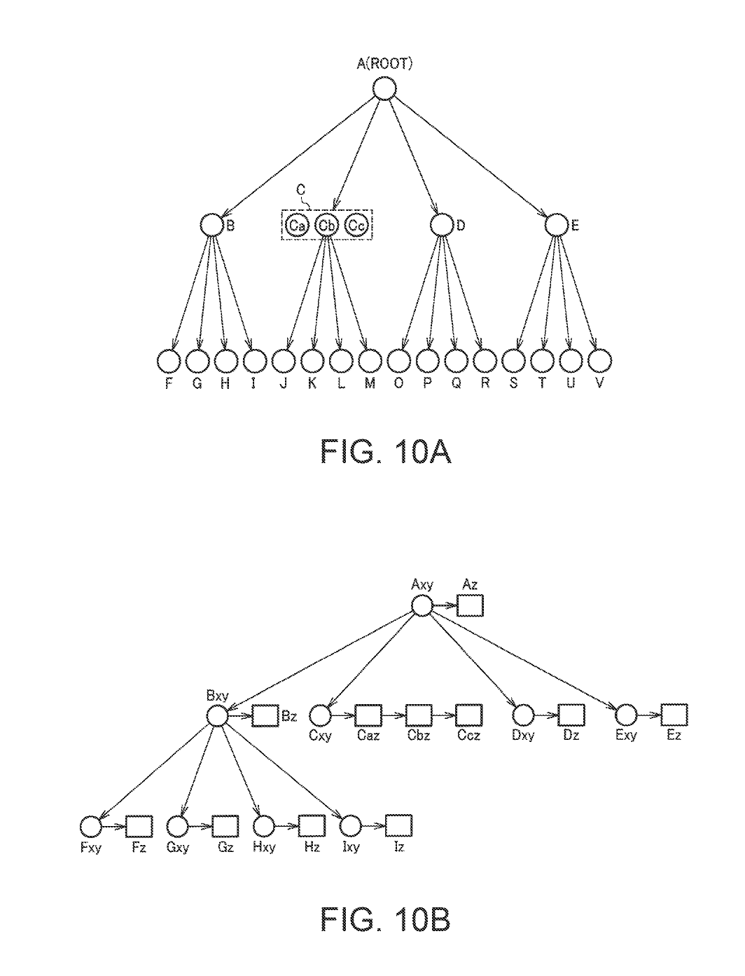

FIG. 10A shows a data configuration example when the representative point complementary processing explained with reference to FIG. 6 etc. is performed. For example, a representative point Ca of the node C is complemented with two representative points Cb, Cc having the same XY-coordinates and different depth values. In this case, the three pieces of representative point data Ca, Cb, Cc having the same XY-coordinates are set on one node C.

Specifically, as shown in FIG. 10B, the XY-coordinates common among the representative point data Ca, Cb, Cc are stored in the node Cxy, and the depth values of the representative point data Ca, Cb, Cc are respectively stored in sub-nodes Caz, Cbz, and Ccz as subordinates to the node Cxy. It is assumed that the sub-nodes Caz, Cbz, and Ccz connected to the node Cxy are formed in a list structure, for example. The data is formed as above, and thereby, the nodes Axy to Vxy should be connected in the quadtree and the data having the quadtree structure may be formed even when the complementary data exists. Note that, in FIG. 10B, the child nodes of the nodes C to E are omitted for simplicity.

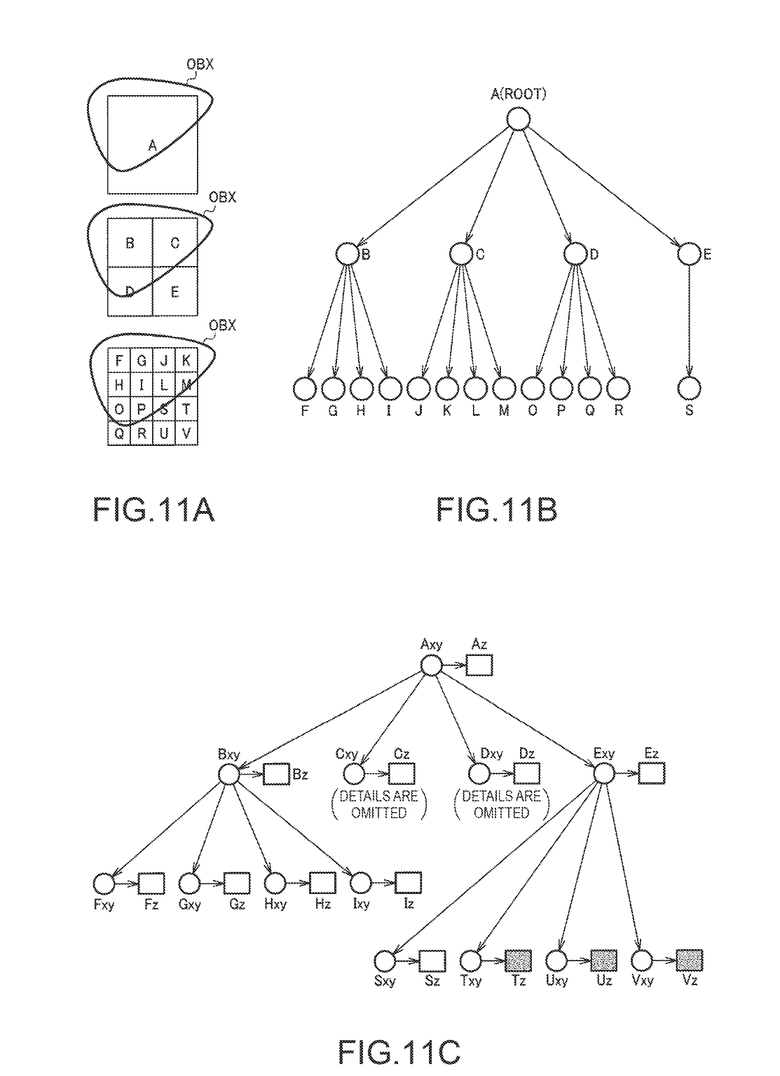

FIG. 11A shows an object OBX and cubic areas as seen from the +Z-direction side. In the example of FIG. 11A, of the areas S to V obtained by division of the area E, the area intersecting with the object OBX is only S. Accordingly, as shown in FIG. 11B, of the child nodes S to V connected to the node E, the representative point exists only in the node S.

In this case, as shown in FIG. 11C, the XY-coordinates and the depth value of the representative point are respectively stored in the node Sxy and the sub-node Sz. No representative point exists in the nodes Txy to Vxy, but the XY-coordinates of the locations in which the representative points are set are stored therein. No depth value is stored in the sub-nodes Tz to Vz, but NULL lists are connected to the nodes Txy to Vxy. For example, in FIG. 11C, when arrows indicating from the nodes Axy to Vxy to the sub-nodes Az to Vz are realized by pointers, for example, in implementation, the arrows indicating the sub-nodes Tz to Vz are realized by NULL pointers, for example. The data is formed as above, and thereby, the nodes Axy to Vxy should be connected by the quadtree and, even when a node with no representative point exists, the data having the quadtree structure may be formed. Note that, in FIG. 11C, for simplicity, the child nodes of the nodes C to E are omitted.

### 4. Technique of Collision Detection

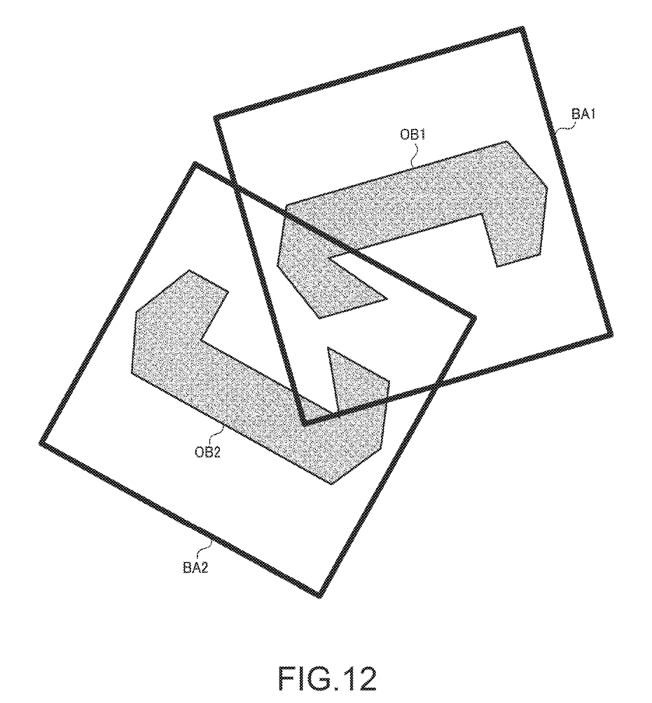

Next, a technique of the collision detection performed by the collision detection system explained with reference to FIG. 1B will be explained. FIG. 12 shows a sectional view of a first object OB1 and a second object OB2 as targets of a collision determination in the world coordinate system. The objects OB1, OB2 are parts of the robot or the like, joint parts connecting the parts, or structures provided in the work space of the robot or the like, for example.

As shown in FIG. 12, the collision determination part 14 first performs a collision determination using representative point data of the cubic area having the maximum size of the collision detection data (i.e., the root data of the quadtree structure). Specifically, the object space setting part 12 performs coordinate conversion of the representative points and the cubic areas of the roots of the quadtree structures from the model coordinate system of the objects OB1, OB2 into the world coordinate system. Then, the collision determination part 14 determines whether or not cubic areas BA1, BA2 of the objects OB1, OB2 intersect in the world coordinate system.

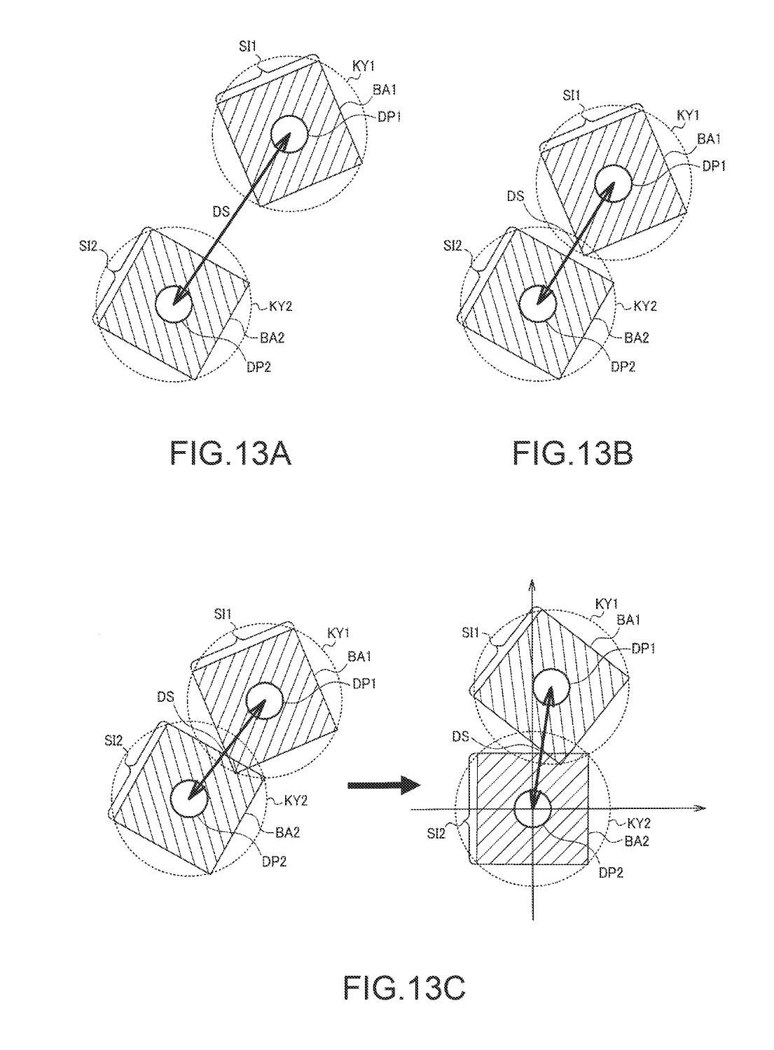

Specifically, as shown in FIG. 13A, the collision determination part 14 obtains a distance DS between a representative point DP1 of the object OB1 and a representative point DP2 of the object OB2. Here, suppose that the length of one side of the cubic area BA1 of the object OB1 is SI1 and the length of one side of the cubic area BA2 of the object OB2 is SI2. If determining that DS>√3×(SI1+SI2) is fulfilled, the collision determination part 14 judges non-intersection between a sphere KY1 including the cubic area BA1 and a sphere KY2 including the cubic area BA2. In this case, non-collision between the cubic areas BA1, BA2 is definitively determined.

On the other hand, as shown in FIG. 13B, if determining that DS>√3×(SI1+SI2) is not fulfilled, the part judges that the spheres KY1, KY2 intersect, and determines whether or not the cubic areas BA1, BA2 intersect. Specifically, as shown in FIG. 13C, the collision determination part 14 performs an intersection determination based on the relative location and the relative rotation angle of the cubic areas BA1, BA2. The relative location and the relative rotation angle may be known from the locations and the positions of the cubic areas BA1, BA2 in the world coordinate system, for example, and the location and rotation angle of the cubic area BA1 may be obtained with reference to the cubic area BA2, for example.

As described above, the intersection determination of the spheres and the intersection determination of the cubic areas are combined, and thereby, the processing may be simplified. That is, when the spheres do not intersect, the process may be ended only with the intersection determination of the spheres as simpler processing than the intersection determination of the cubic areas. Note that, as above, whether or not the cubic areas intersect is determined if the determination that the spheres intersect has been made, however, in the embodiment, a collision between the cubic areas may be definitively determined when the determination that the spheres intersect is made. In this case, the processing may be further simplified.

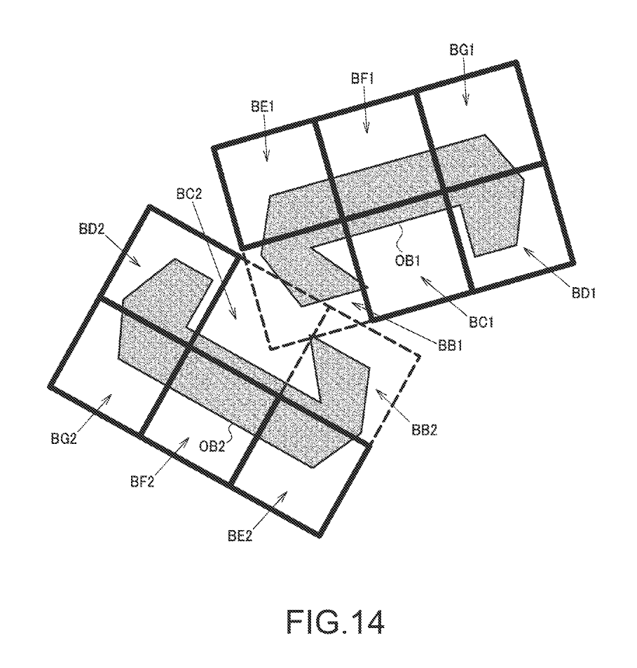

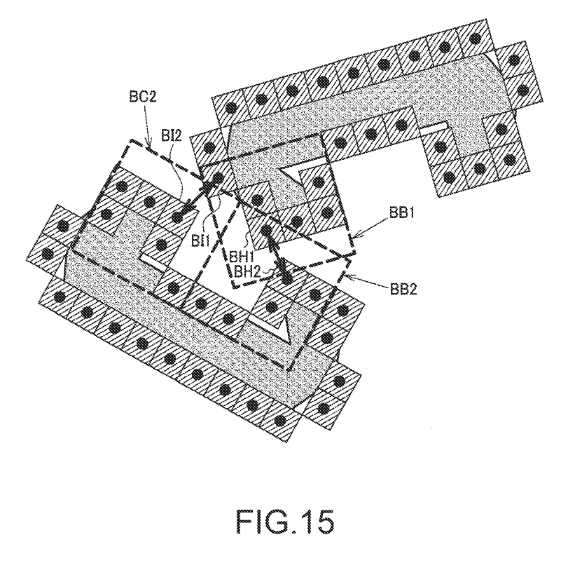

If the determination that the cubic areas BA1, BA2 intersect is made in the intersection determination, the collision determination part 14 performs a collision determination in the cubic areas having the smaller size than those of the cubic areas BA1, BA2. That is, as shown in FIG. 14, intersection determinations between cubic areas BB1 to BG1 formed by division of the cubic area BA1 and cubic areas BB2 to BG2 formed by division of the cubic area BA2 are performed with respect to all combinations. For example, if the determination that the cubic area BB1 and the cubic areas BB2, BC2 intersect is made, as shown in FIG. 15, intersection determinations between cubic areas formed by further division of the cubic areas BB1, BB2, BC2 are made.

Specifically, if determining non-intersection between cubic areas BH1, BH2 having the representative points closest to each other within the cubic areas BB1, BB2 and non-intersection between cubic areas BI1, BI2 having the representative points closest to each other within the cubic areas BB1, BC2, the collision determination part 14 definitively determines non-collision between the objects OB1, OB2. On the other hand, if cubic areas determined to intersect exist and the layer for determination is the lowermost layer of the quadtree structure, the part definitively determines a collision probability between the objects OB1, OB2.

Note that, in FIGS. 14 and 15, the collision determination for one layer of the quadtree structure is omitted and the collision determination in the next lower layer is shown, however, in practice, the collision determination is performed with respect to each layer.

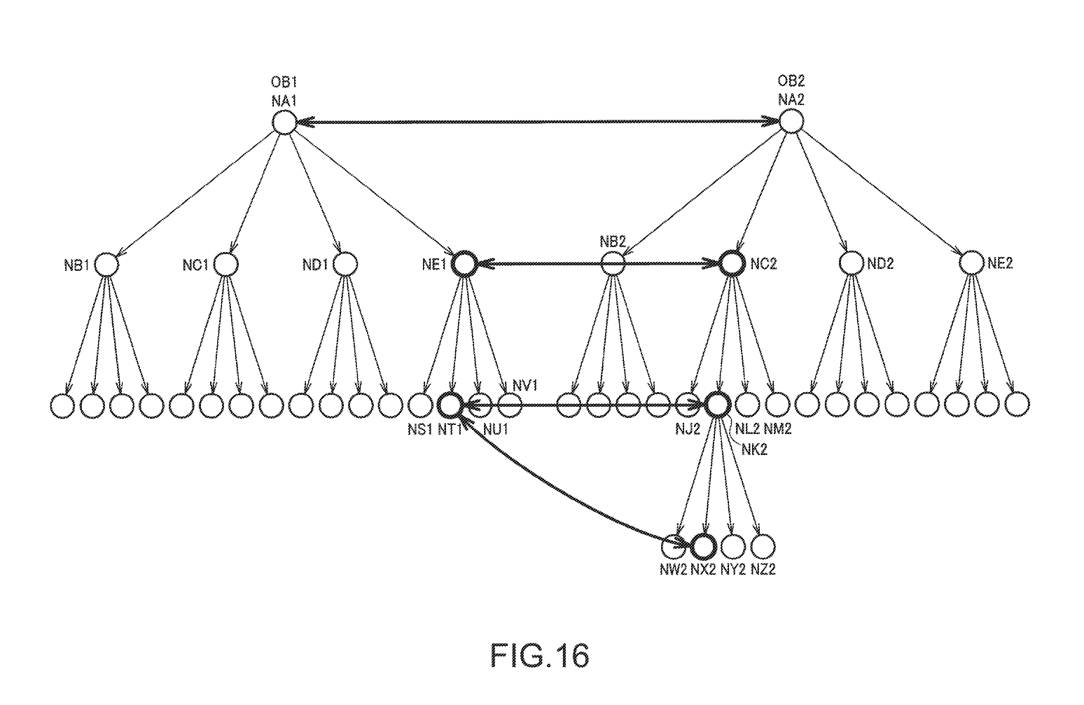

That is, as shown in FIG. 16, the collision determination part 14 first performs a collision determination using representative point data of nodes NA1, NA2 of the roots in the data having the quadtree structures of the objects OB1, OB2. Then, if determining that the cubic areas of the nodes NA1, NA2 intersect, the part performs collision determinations with respect to all combinations using representative point data of child nodes NB1 to NE1, NB2 to NE2 of the nodes NA1, NA2. For example, if determining that the cubic areas of the nodes NE1, NC2 intersect, the part performs collision determinations with respect to all combinations of the representative point data using representative point data of child nodes NS1 to NV1 of the node NE1 and child nodes NJ2 to NM2 of the node NC2. On the other hand, with respect to the child nodes of the nodes for which non-intersection of the cubic areas has been determined, no further collision determination is performed.

In the collision determinations of the nodes NS1 to NV1, NJ2 to NM2, for example, suppose that the determination that the cubic areas of the nodes NT1, NK2 intersect is made. In the example of FIG. 16, the node NT1 is the node in the lowermost layer, and the node NK2 has lower child nodes. In this case, the collision determination part 14 performs collision determinations using the representative point data of the node NT1 and the representative point data of the child nodes NW2 to NZ2 of the node NK2. If determining that the cubic area of the node NT1 and the cubic area of the node NX2 as a node of the lowermost layer, for example, intersect, a collision probability between the objects OB1, OB2 is definitively determined. On the other hand, if non-collision is determined with respect to all nodes in one layer, non-collision between the objects OB1, OB2 is definitively determined at the time, and the collision determination with respect to the objects OB1, OB2 is ended.

As described above, in the collision detection technique using polygon data of related art, there has been a problem that many objects without available CAD data exist in practice, and the technique is difficult to be applied to the objects. Further, there have been problems that processing becomes redundant depending on the size of the polygons and unwanted processing is performed because many pieces of polygon data not important for the collision detection is contained.

In this regard, in the embodiment, as explained with reference to in FIG. 3 etc., the collision detection data generation part 114 discretizes the depth map data using the cubic area CA set in the model coordinate system of the object OB, and thereby, generates data of the representative points PA in the model coordinate system of the object OB as collision detection data. Here, the model coordinate system is a coordinate system of a model space set with respect to each object as the target of collision detection. Further, the cubic area is a cube having sides respectively in the same length in the model space, and the length of the side corresponds to the depth width and the distance in the planar direction on the depth map data. Furthermore, the representative point data is data representing representative points representing the locations of the cubic areas (for example, center points of the cubic areas), and data of the representative depth values and representative locations on the depth map data (or XYZ-coordinate data in the model coordinate system).

In addition, in the embodiment, the memory unit 50 stores the data of the representative points PA as the collision detection data, and the processing unit 10 performs the collision determination of the first object and the second object in the world coordinate system based on the first collision detection data corresponding to the first object and the second collision detection data corresponding to the second object. Here, the world coordinate system corresponds to a workspace of the robot or the like, for example, and the object as the target of collision detection is placed in the world coordinate system by coordinate conversion from the model coordinate system.

As described above, in the embodiment, the collision detection data may be generated from the depth map data, and thus, collision detection may be performed without CAD data. For example, if an object without CAD data exists among the objects as the targets of collision detection, the depth map data of the object is acquired using a 3D scanner or the like, and thereby, collision detection data may be created.

Further, the model space is discretized using the cubic areas, and thus, representative point data does not vary in size unlike the polygons, or redundant overlapping is not generated unlike the case where the polygons are covered by spheres. The processing load of the collision detection may be reduced using the non-redundant data. Furthermore, the representative points may be set only on the outer surface of the object using the depth map data, and thus, data of the interior of the object is not generated unlike the case of using the polygons, and unwanted processing not important for collision detection may be eliminated. In addition, the number of node pairs for collision detection is proportional to the square of the number of nodes, and thus, in the embodiment in which no redundant data or unwanted data is generated, speeding up of the processing may be expected.

Here, the node pair is a pair of nodes selected as a determination target of collision determination. When a collision determination between the first object OB1 and the second object OB2 explained with reference to FIG. 16 is performed, a combination of one node selected from the data of the OB1 and one node selected from the data of the OB2 forms a node pair. In the embodiment, a collision determination is performed with respect to each layer on child nodes of the node determined to collide, and thus, for example, one node is selected from the child nodes NS1 to NV1 of the NE1 in the third layer of the OB1, one node is selected from the child nodes NJ2 to NM2 of the NC2 in the third layer of the OB2, and thereby, a node pair is selected. As described above, in the embodiment, the combination of the nodes selected from the layers as the targets of determination and the child nodes as the targets of determination form the node pair.

Further, in the embodiment, the memory unit 50 stores representative point data (node A in FIG. 9B) of the bounding box (area Ain FIG. 9A) including the object OB and divisional representative point data (nodes B to E) obtained by discretization of the depth map data using cubic areas (areas B to E) formed by division of the bounding box as collision detection data. If determining that a bounding box including the first object OB1 (node NA1 in FIG. 16) and a bounding box including the second object OB2 (node NA2) will collide, the processing unit 10 performs a collision determination based on the divisional representative point data (nodes NB1 to NE1) of the first object OB1 and the divisional representative point data (nodes NB2 to NE2) of the second object OB2.

In this manner, non-collision between the first object and the second object is definitively determined without processing of the divisional representative point data at the stage of determination of non-collision between the bounding boxes, and thereby, the processing may be simplified.

More specifically, the collision detection data generation part 114 connects the nodes (nodes F to I) corresponding to a plurality of cubic areas (areas F to I) formed by division of the cubic area (area B in FIG. 9A) of a parent node (for example, the node B in FIG. 9B) as child nodes to the parent node, and generates data having a tree structure as collision detection data. The memory unit 50 of the collision detection system stores the data having the tree structure and the processing unit 10 performs collision detection based on the data having the tree structure.

Using the data having the tree structure, recursive collision detection of node pairs becomes possible and, for example, parallel processing using a CPU or the like may be easily realized. Specifically, in the embodiment, the data having the quadtree structure is generated, and, using the data having the quadtree structure, collision detection of 4×4=16 node pairs is performed in each layer of the recursive collision detection. Accordingly, without using a GPU (Graphics Processing Unit) capable of performing several tens to hundreds of thousands parallel processing, the collision detection system may be realized using a CPU that performs parallel processing of about several tens of threads and the cost reduction by omission of the GPU may be realized.

Note that the data having the tree structure in the embodiment is not limited to the data having the quadtree structure, but may be data in which nodes of the minimum cubic areas are directly connected to the nodes of the bounding boxes (without intermediate layers), for example. In this case, the number of combinations of node pairs of the minimum cubic areas is larger, and formation of the collision detection system using the GPU is assumed.

### 5. Detailed Configuration of Collision Detection Data Generator

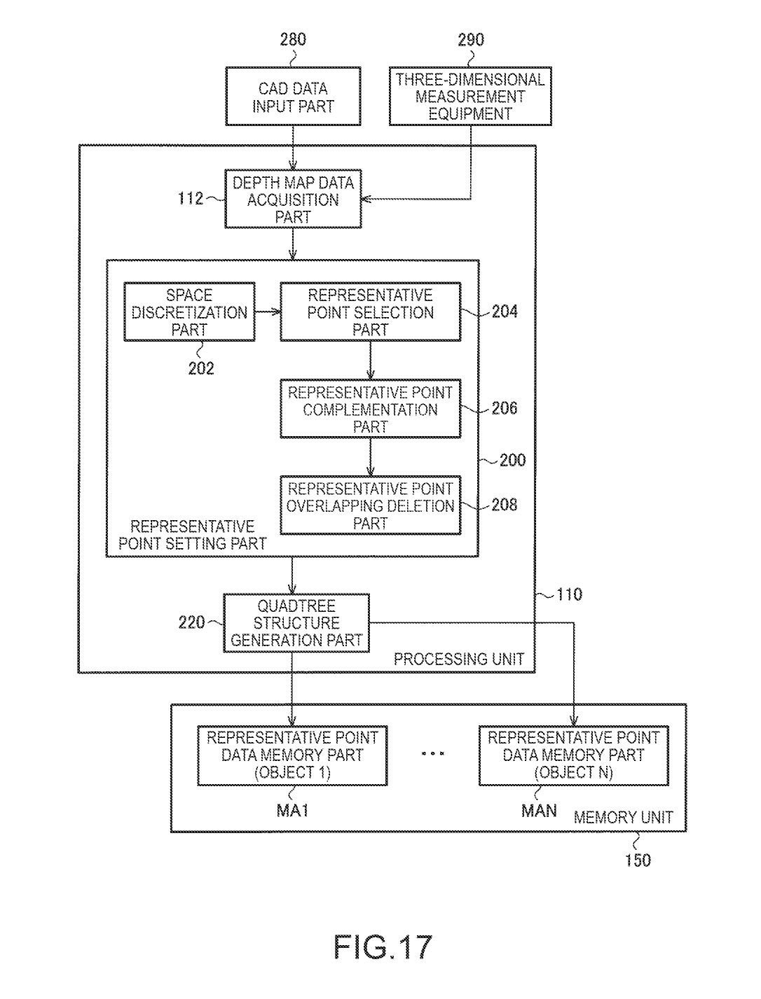

FIG. 17 shows a detailed configuration example of the collision detection data generator of the embodiment. The collision detection data generator includes the processing unit 110 and the memory unit 150. The processing unit 110 includes the depth map data acquisition part 112, a representative point setting part 200, and a quadtree structure generation part 220. The memory unit 150 includes representative point data memory parts MA1 to MAN that store collision detection data of objects 1 to N.

The representative point setting part 200 performs processing of discretizing a model space and setting representative points, and includes a space discretization part 202, a representative point selection part 204, a representative point complementation part 206, and a representative point overlapping deletion part 208. Note that the representative point setting part 200 and the quadtree structure generation part 220 correspond to the collision detection data generation part 114 in FIG. 1A.

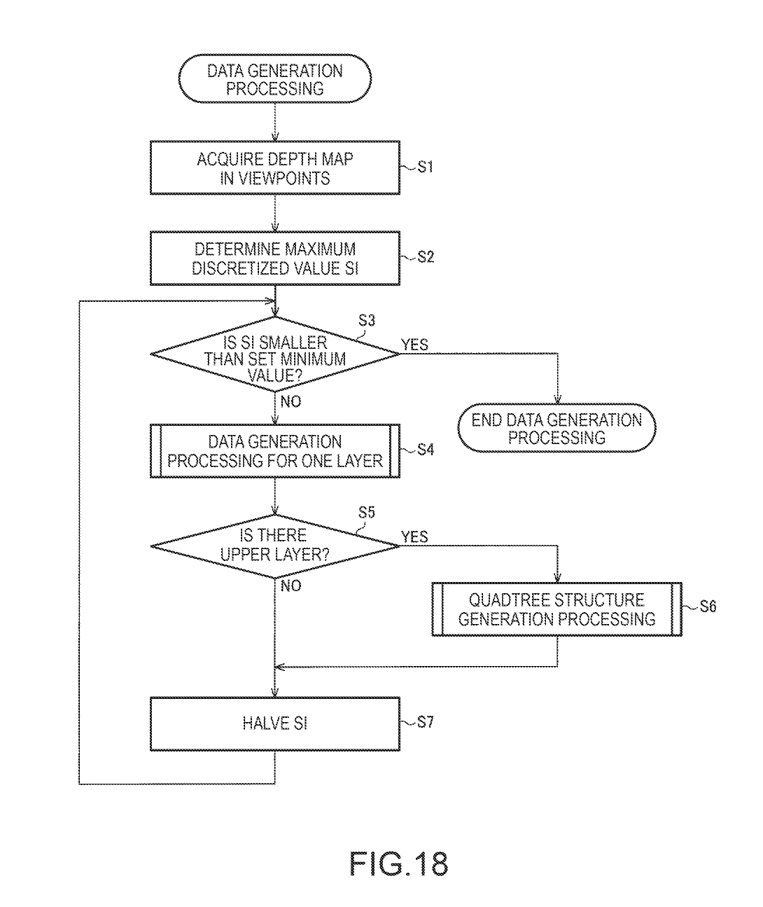

Next, a detailed processing example of the collision detection data generator will be explained using flowcharts in FIGS. 18 to 20.

As shown in FIG. 18, when data generation processing is started, the depth map data acquisition part 112 acquires depth map data in a plurality of viewpoints (step S1). The depth map data acquisition part 112 draws an object as seen from the viewpoints and generates depth map data with respect to the respective viewpoints based on CAD data (polygon data) input from a CAD data input part 280, for example. Alternatively, the part acquires depth map data based on information input from three-dimensional measurement equipment 290. As the three-dimensional measurement equipment 290, for example, a 3D scanner, a stereo camera, or the like is assumed. In the case of the 3D scanner, the depth map data acquisition part 112 acquires depth map data generated by the 3D scanner.

Then, the space discretization part 202 sets the length of one side of the cubic area of the root node (the maximum discretized value) as a discretized value S1 (step S2). Then, the space discretization part 202 determines whether or not the discretized value SI is smaller than a preset predetermined minimum value (step S3). The predetermined minimum value is set to a value smaller than a tolerance, for example, in consideration of the location grasp accuracy of the robot or the like. If the discretized value SI is smaller than the predetermined minimum value, data is stored in the corresponding memory part of the representative point data memory parts MA1 to MAN, and the data generation processing is ended. If the discretized value SI is equal to or larger than the predetermined minimum value, data generation processing for one layer of the quadtree structure is performed (step S4). The detail of the data generation processing for one layer will be described later.

Then, the quadtree structure generation part 220 determines whether or not an upper layer than the layer for which the data is generated at step S4 exists (step S5). If the upper layer exists, the quadtree structure generation part 220 performs processing of forming the data generated at step S4 in a quadtree structure (step S6), and the space discretization part 202 executes step S7. The detail of quadtree structure generation processing will be described later. If the upper layer does not exist, the space discretization part 202 updates the discretized value SI to a half value (step S7), and executes step S3 again.

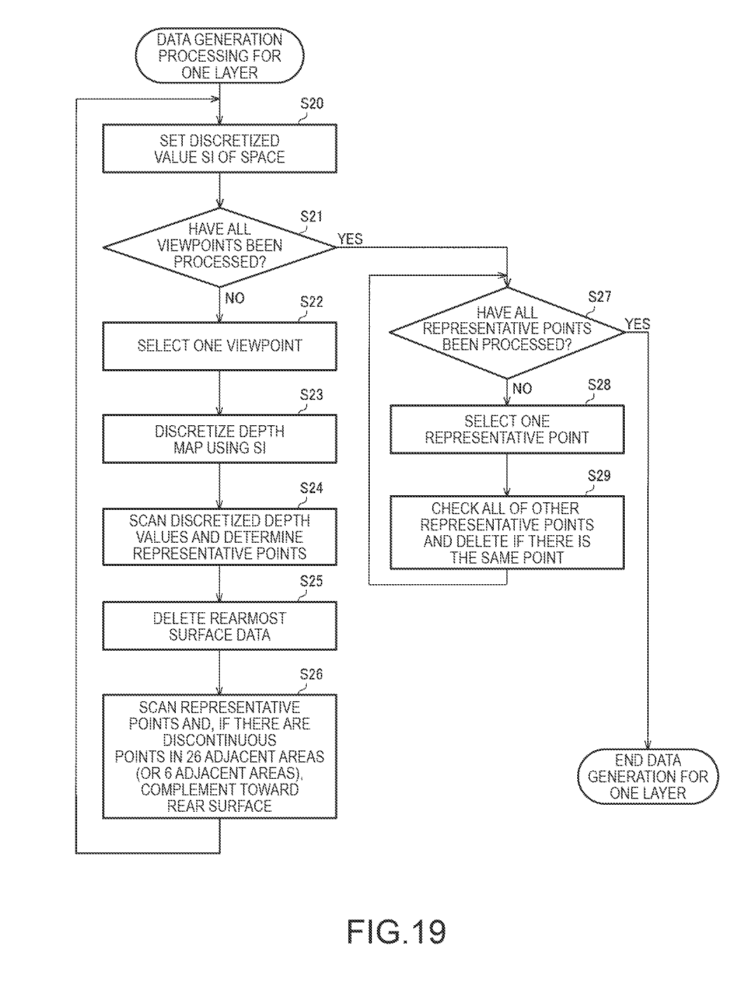

FIG. 19 shows a detailed flowchart of the data generation processing for one layer at step S4. Note that, in FIG. 19, the case where the depth value is larger as farther in the direction of the viewpoint will be explained, and the embodiment is not limited to that.

When the processing is started, the space discretization part 202 sets the discretized value SI of the model space (step S20). Then, the space discretization part 202 determines whether or not setting processing of the representative points has been performed with respect to all of the viewpoints (step S21). If unprocessed viewpoints exist, the part selects one viewpoint from the unprocessed viewpoints (step S22). Then, the space discretization part 202 discretizes the depth map data using the cubic areas with one side having the length of the discretized value SI (step S23).

Then, the representative point selection part 204 scans the discretized depth map data and sets the representative points (step S24). Then, the representative point selection part 204 deletes the representative point data on the rearmost surface in the depth map (step S25). The representative point data on the rearmost surface includes representative points having the maximum depth values (or around the values) in the depth value range that can be taken.

Then, the representative point complementation part 206 scans the set representative points and, if the representative points are not continuously set between the representative points and representative points outside of 26 adjacent areas of the representative points, complements the rear surface side (the side with the larger depth values, for example, the −Z-direction side in FIG. 5) of the representative points with representative points (step S26). Specifically, the representative point complementation part 206 obtains a difference DV resulting from subtraction of the depth value of the representative point (B4) existing in the representative locations adjacent to the representative point from the depth value of the representative point of interest (for example, B2 in FIG. 5). Here, the adjacent representative locations include eight representative locations around the representative location of the representative point of interest when the representative point of interest is seen from the viewpoint. Then, if the difference DV<0 and |DV|>SI, the representative point complementation part 206 complements the rear surface side (B1) of the representative point of interest with the |DV|/SI representative points. When step S26 is ended, the part executes step S20.

At step S21, if the representative points have been set with respect to all of the viewpoints, the representative point overlapping deletion part 208 determines whether or not processing of deleting the overlapping representative points among the representative points of the viewpoints has been performed on all representative points (step S27). If unprocessed representative points exist, the representative point overlapping deletion part 208 selects one representative point from the unprocessed representative points (step S28). The representative point overlapping deletion part 208 compares the selected representative point with all other representative points and, if the same representative point exists, deletes the same representative point (step S29), and executes step S27. At step S27, if the processing has been finished with respect to all representative points, the part ends the data generation processing for one layer.

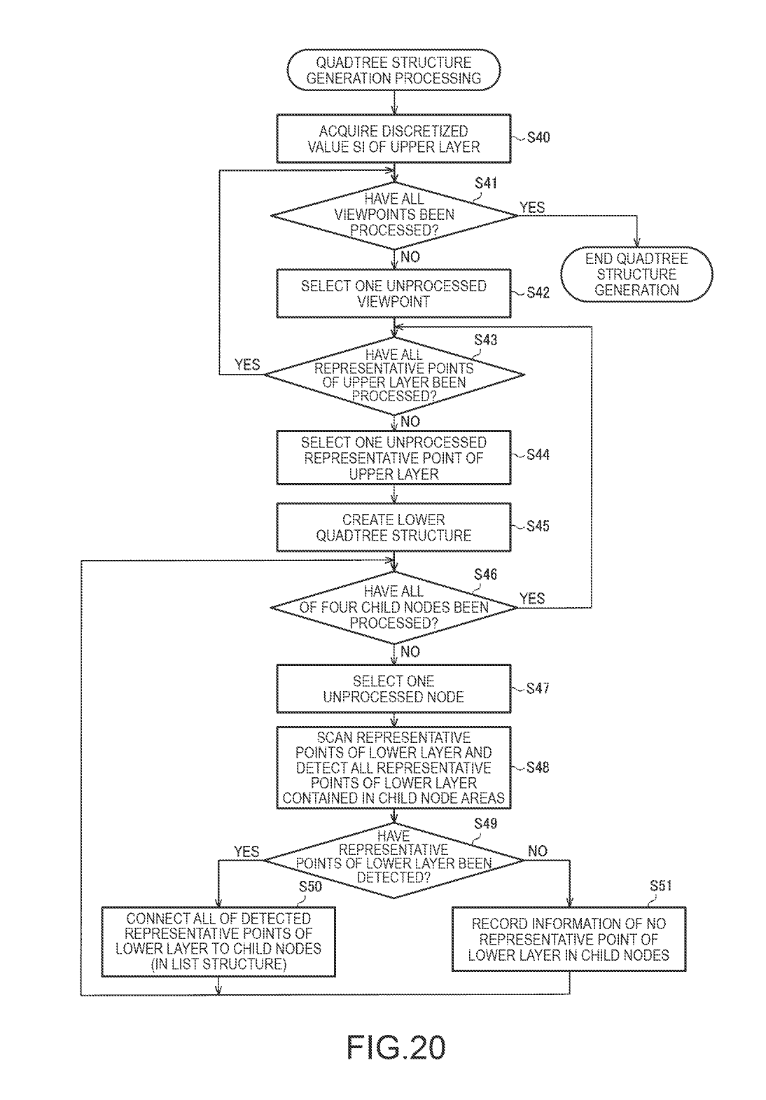

FIG. 20 shows a detailed flowchart of the quadtree structure generation processing at step S6. When the processing is started, the quadtree structure generation part 220 acquires the discretized value SI of the upper layers than the layers for which the data has been generated at step S4 (step S40). Then, the quadtree structure generation part 220 determines whether or not the processing has been performed with respect to all of the viewpoints (step S41). If the processing has been finished with respect to all of the viewpoints, the part ends the quadtree structure generation processing. If unprocessed viewpoints exist, the part selects one viewpoint from the unprocessed viewpoints (step S42).

Then, the quadtree structure generation part 220 determines whether or not the processing has been performed with respect to all representative points of the upper layers (step S43). For example, when the nodes F to V in FIG. 9B are processed, determinations are performed with respect to all of the nodes B to C as the upper layers. If the processing has been finished with respect to all representative points of the upper layers, the part executes step S41. If unprocessed representative points exist, the quadtree structure generation part 220 selects one representative point from the unprocessed representative points (step S44). Then, the quadtree structure generation part 220 connects the selected representative points as parent nodes to the representative points of the child nodes, and forms a quadtree structure of the lower layers (step S45). For example, when the node Bxy in FIG. 9C is selected, the node Bxy is the parent node and child nodes Fxy to Ixy, Fz to Iz are connected to the node Bxy. The XY-coordinates of the representative locations are set on the nodes Fxy to Ixy, and the nodes Fz to Iz are empty nodes (for example, NULL nodes) at the time.

Then, the quadtree structure generation part 220 determines whether or not setting processing of the representative point data has been performed with respect to all of the four child nodes (step S46). If the processing has been finished with respect to all of the four child nodes, the part executes step S43. If unprocessed child nodes exist, the quadtree structure generation part 220 selects one child node from the unprocessed child nodes (step S47). Then, the quadtree structure generation part 220 detects the representative point existing in the representative location of the selected child node (step S48).

Then, the part determines whether or not the representative point has been detected in the representative location of the selected child node (step S49). If the representative point has been detected, the quadtree structure generation part 220 connects all of the detected representative points to the child nodes (step S50). For example, when the node Fxy in FIG. 9C is selected and only one representative point is detected, the part connects the representative depth value of the one representative point as the node Fz to the node Fxy. Or, when a plurality of representative points are detected as in the node Cxy in FIG. 10B, the part connects the representative depth values of the representative points as nodes Caz to Ccz of a list structure to the node Cxy. If no representative point has been detected at step S49, the quadtree structure generation part 220 sets information that no representative point exists in the child nodes (step S51). For example, as has been explained with reference to FIG. 11C, the NULL node Tz is connected to the node Txy. If steps S50, S51 are finished, the part executes step S46.

### 6. Detailed Configuration of Collision Detection System

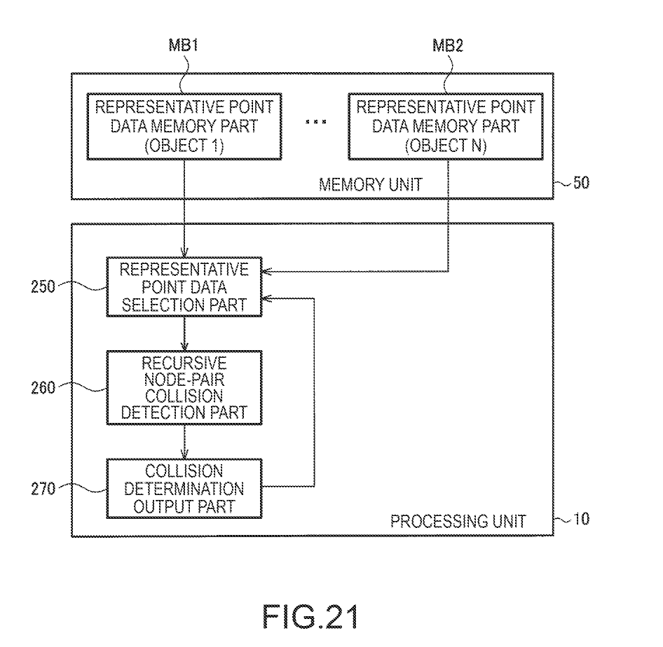

FIG. 21 shows a detailed configuration example of the collision detection system of the embodiment. The collision detection system includes the processing unit 10 and the memory unit 50. The processing unit 10 includes a representative point data selection part 250, a recursive node-pair collision detection part 260, and a collision determination output part 270. The memory unit 50 includes representative point data memory parts MB1 to MBN that store collision detection data of objects 1 to N.

Note that the representative point data selection part 250, the recursive node-pair collision detection part 260, and the collision determination output part 270 correspond to the collision determination part 14 and the object space setting part 12 in FIG. 1B. Here, when the collision detection system is integrally formed with the collision detection data generator, the representative point data memory parts MB1 to MBN and the representative point data memory parts MA1 to MAN in FIG. 17 may be shared.

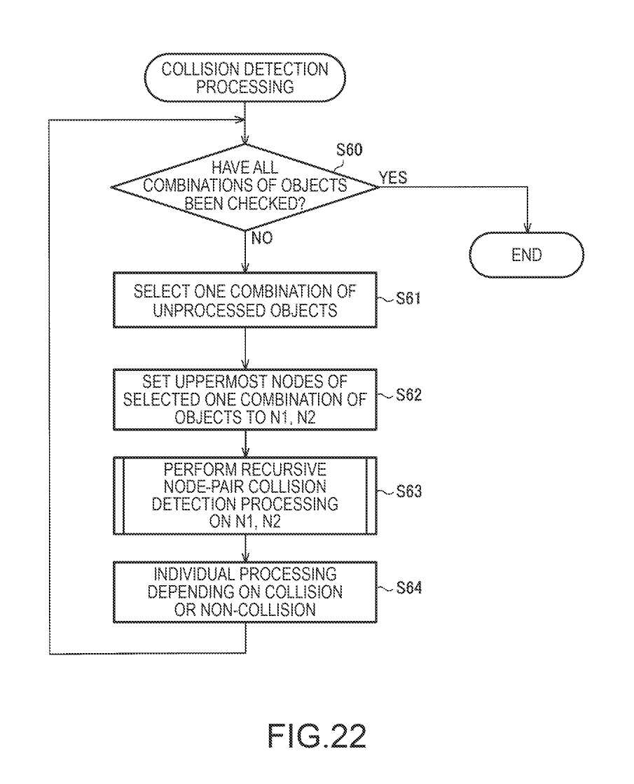

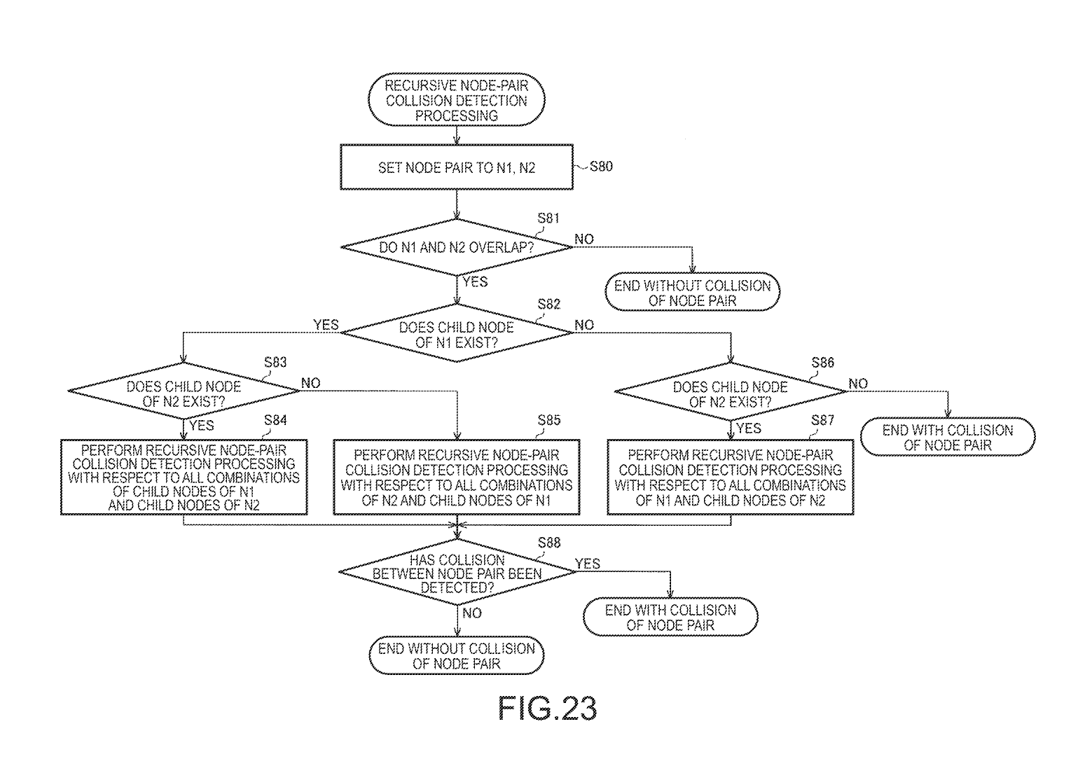

Then, the detailed processing example of the collision detection system will be explained using flowcharts in FIGS. 22, 23.

As shown in FIG. 22, when collision detection processing is started, the representative point data selection part 250 determines whether or not the collision detection processing has been performed with respect to all combinations of objects (step S60). If unprocessed combinations exist, the representative point data selection part 250 selects one combination of objects (the first object, the second object) from the unprocessed combinations (step S61).

Then, the recursive node-pair collision detection part 260 sets the uppermost node of the first object to a node N1 and sets the uppermost node of the second object to a node N2 (step S62). Then, the recursive node-pair collision detection part 260 performs recursive node-pair collision detection processing on the nodes N1, N2 (step S63). The details of the recursive node-pair collision detection processing will be described later. Then, the collision determination output part 270 outputs a collision determination result, and the processing unit 10 performs various processing in response to the collision determination result (step S64). For example, if a collision is determined, the processing unit 10 performs processing of correcting the trajectory of the object, processing of stopping the movement, or the like for prevention of the collision. If step S64 is finished, the part executes step S60. At step S60, if the processing has been finished with respect to all combinations of objects, the part ends the collision detection processing.

FIG. 23 shows a detailed flowchart of the recursive node-pair collision detection processing. When the processing is started, the recursive node-pair collision detection part 260 sets nodes N1, N2 as the node pair to be processed (step S80). Then, the part determines whether or not cubic areas of the nodes N1, N2 overlap in the world coordinate system (step S81). If there is no overlap, non-collision between the nodes N1, N2 is judged and the processing is ended. If there is an overlap, the recursive node-pair collision detection part 260 determines whether or not a child node of the node N1 exists (step S82).

If the child node of the node N1 exists, the recursive node-pair collision detection part 260 determines whether or not a child node of the node N2 exists (step S83). If the child node of the node N2 exists, the part recursively performs collision detection of the node pairs with respect to all combinations of the child nodes of the nodes N1, N2 (step S84). That is, if a combination in which the cubic areas overlap (for example, nodes NE1, NC1 in FIG. 16) exists in the combinations of the child nodes of the nodes N1, N2, the part newly sets the node pair as the nodes N1, N2, and executes step S81 and the subsequent steps again. The recursive collision detection is performed with respect to all node pairs determined to have the overlapping cubic areas at step S84. If the node pairs having the overlapping cubic areas exist to the lowermost layer, the recursive processing is repeated to the lowermost layer. If no child node of the node N2 exists at step S83, the recursive node-pair collision detection part 260 performs recursive collision detection with respect to all combinations of the child nodes of the node N1 and the node N2 (step S85).

If no child node of the node N1 exists at step S82, the recursive node-pair collision detection part 260 determines whether or not a child node of the node N2 exists (step S86). If the child node of the node N2 exists, the part recursively performs collision detection of the node pairs with respect to all combinations of the node N1 and the child nodes of the node N2 (step S87). If no child node of the node N2 exists, the part determines a collision probability between the nodes N1, N2, and ends the processing.

If steps S84, S85, S87 are executed, the recursive node-pair collision detection part 260 determines whether or not a collision has been detected for the node pair of the lowermost layer in the recursive node-pair collision detection (step S88), and outputs the determination result and ends the processing.

Note that the embodiment has been explained in detail as described above, and a person who skilled in the art could easily understand that many modifications without substantially departing from the new matter and the advantages of the invention may be made. Accordingly, the modifications may be within the scope of the invention. For example, in the specification or the drawings, the terms described with different broader or synonymous terms at least once may be replaced by the different terms in any part of the specification or the drawings. Further, all combinations of the embodiment and the modified examples may be within the scope of the invention. Furthermore, the configuration and the operation of the collision detection data generator and the collision detection system, the technique of generating the collision detection data, the technique of collision detection, etc. are not limited those explained in the embodiment, but various modifications may be implemented.

The entire disclosure of Japanese Patent Application No. 2012-161281, filed Jul. 20, 2012 is expressly incorporated by reference herein.

What is claimed is:

1. A collision detection system comprising:
a memory unit that stores first collision detection data corresponding to a first object and second collision detection data corresponding to a second object as collision detection data of the objects; and
a processing unit that performs a collision determination between the first object and the second object in the world coordinate system based on the first collision detection data and the second collision detection data,
wherein the memory unit stores representative point data obtained by discretization of depth map data of the objects as seen from a predetermined viewpoint in model coordinate systems of the objects using cubic areas set in the model coordinate systems as the collision detection data.

2. The collision detection system according to claim 1, wherein the memory unit stores the representative point data of bounding boxes including the objects and divisional representative point data as the representative point data obtained by discretization of the depth map data using cubic areas formed by division of the bounding boxes as the collision detection data, and
if determining a collision between the first bounding box including the first object and the second bounding box including the second object, the processing unit performs the collision determination between the first object and the second object based on the divisional representative point data of the first object and the divisional representative point data of the second object.

3. The collision detection system according to claim 1, wherein the memory unit stores data having a tree structure as the collision detection data, and
the data having the tree structure has the representative point data corresponding to a plurality of cubic areas formed by division of a cubic area of a parent node as the representative point data of child nodes branching from the parent node.

4. The collision detection system according to claim 3, wherein the plurality of cubic areas of the child nodes formed by division of the cubic area of the parent node are 2×2×2 cubic areas obtained by division of the cubic area of the parent node as seen from the predetermined viewpoint into 2×2 areas and division of the respective areas of the 2×2 areas into two in a depth direction of the predetermined viewpoint,
the data having the tree structure is data having a quadtree structure in which the child nodes are set in correspondence with the respective areas of the 2×2 areas as seen from the predetermined viewpoint, and
the data of the child nodes in the quadtree structure is the representative point data existing in at least one of the two cubic areas in the depth direction in the respective areas of the 2×2 areas.

5. The collision detection system according to claim 3, wherein, if the parent node determined to collide exists in the collision determination based on the data of the parent node, the processing unit performs the collision determination based on the data of the child nodes branching from the parent node determined to collide, and
if the parent node determined to collide does not exist in the collision determination based on the data of the parent node, the processing unit definitively determines non-collision between the first object and the second object.

6. The collision detection system according to claim 1, wherein the depth map data is depth map data generated by three-dimensional information measurement equipment that measures three-dimensional information of the objects.

7. A collision detection data generator comprising:
a depth map data acquisition unit that acquires depth map data of an object as seen from a predetermined viewpoint in a model coordinate system of the object; and
a collision detection data generation unit that generates representative point data in the model coordinate system of the object as collision detection data,
wherein the collision detection data generation unit generates the representative point data by discretization of the depth map data using cubic areas set in the model coordinate system of the object.

8. The collision detection data generator according to claim 7, wherein the collision detection data generation unit generates data having a tree structure as the collision detection data by connecting nodes corresponding to a plurality of cubic areas formed by division of a cubic area of a parent node as child nodes to the parent node.

9. The collision detection data generator according to claim 8, wherein the plurality of cubic areas of the child nodes formed by division of the cubic area of the parent node are 2×2×2 cubic areas obtained by division of the cubic area of the parent node as seen from the predetermined viewpoint into 2×2 areas and division of the respective areas of the 2×2 areas into two areas in a depth direction of the predetermined viewpoint,
the collision detection data generation unit generates data having a quadtree structure in which the child nodes are set in correspondence with the respective areas of the 2×2 areas as seen from the predetermined viewpoint as the data having the tree structure, and
the data of the child nodes in the data having the quadtree structure is the representative point data existing in at least one of the two cubic areas in the depth direction in the respective areas of the 2×2 areas.

10. The collision detection data generator according to claim 7, wherein, if judging that there is a cubic area without the representative point data between the representative point as a target of processing and representative points existing outside of the surrounding 26 adjacent cubic areas of the representative point as the target of processing, the collision detection data generation unit complements the cubic area without the representative point data with the representative point data.

11. The collision detection data generator according to claim 10, wherein, when a depth value is larger as farther in the depth direction of the predetermined viewpoint, if determining that a difference value obtained by subtraction of a representative depth value of the representative points existing around the representative point as the target of processing from a representative depth value of the representative point as the target of processing is negative, the collision detection data generation unit complements the cubic area at the depth direction side with respect to the representative point as the target of processing with the representative point data.

12. The collision detection data generator according to claim 7, wherein the depth map data is depth map data generated by three-dimensional information measurement equipment that measures three-dimensional information of the object.

13. A robot comprising:
a movable unit;
a memory unit that stores first collision detection data corresponding to a first object and second collision detection data corresponding to a second object as collision detection data of the objects;
a processing unit that performs a collision determination between the first object and the second object in the world coordinate system based on the first collision detection data and the second collision detection data; and
a control unit that controls a movement of the movable unit based on a result of the collision determination performed by the processing unit,
wherein the memory unit stores representative point data obtained by discretization of depth map data of the objects as seen from a predetermined viewpoint in model coordinate systems of the objects using cubic areas set in the model coordinate systems as the collision detection data.
